(19) United States
(12) Patent Application Publication
(10) Pub. No.: US 2022/0142391 A1
(43) Pub. Date: May 12, 2022

(54) HIGH HEAT FLUX PAN

(71) Applicant: Bodhe Wayne Scheerer, Minneapolis, MN (US)

(72) Inventor: Bodhe Wayne Scheerer, Minneapolis, MN (US)

(21) Appl. No.: 17/454,297

(22) Filed: Nov. 10, 2021

Related U.S. Application Data
(60) Provisional application No. 63/112,479, filed on Nov. 11, 2020.

(51) Int. Cl. A47J 27/026

(52) U.S. Cl. CPC A47J 27/026

(57) ABSTRACT

A cooking vessel including a base, an inner wall extending upwardly away from the base, and an outer wall at least partially surrounding the inner wall, the base defining at least one of a filleted or chamfered peripheral edge, the inner and outer walls cooperating to define an exit nozzle having an area relative to the overall channel volume or cross sectional area.

### RELATED APPLICATION INFORMATION

This application claims the benefit of U.S. Provisional Application No. 63/112,479, filed Nov. 11, 2020, the contents of which are fully incorporated herein by reference.

### TECHNICAL FIELD

The present disclosure relates generally to cooking devices and more particularly to high heat flux cookware configured to enable improved airflow around heating surfaces, resulting in enhanced heating and cooking efficiency.

### BACKGROUND

Traditional cast-iron cookware (e.g., skillets, pans, Dutch ovens, etc.) is a popular choice for professional and amateur chefs, outdoor cooking enthusiasts and bakers for a number of reasons. In particular, cast-iron pans are capable of storing large amounts of heat energy such that food items can be placed within the cookware without rapidly lowering the temperature of the cookware. Moreover, cast-iron provides a consistent heating surface over a variety of heat sources, such as a gas range, grill, open fire, oven, etc. As such, cast-iron cookware is known to an excel at certain tasks, such as searing food, wherein the cookware is heated to a high temperature, typically above 600° F. prior to placing food within the cookware, such that heat energy stored by the cookware is rapidly transferred into the food, thereby searing/caramelizing the contacting surfaces of the food.

Although cast-iron is capable of storing and retaining relatively large amounts of thermal energy, compared to other metals (e.g., copper or aluminum) cast-iron has a relatively low thermal conductivity. Accordingly, traditional cast-iron cookware can take a significant amount of time to change in temperature. For example, when searing food, heat energy is rapidly transferred from the cookware to the food, which can cause the cookware to cool below the temperature needed for a proper sear; thereafter, it can take a significant amount of time to reheat the cookware above the searing threshold to ensure proper searing of other surfaces of the food, or when using the cast iron cookware in a continuous manner to sear larger quantities of food.

The present disclosure addresses this concern, among others.

### SUMMARY OF THE DISCLOSURE

Embodiments of the present disclosure provide a High Heat Flux Pan (HHFP) (alternatively referred to herein as a “cooking vessel”) that modifies, but does not completely alter, the flow of hot gas around the pan. Over a focused heat source (FHS), such as a gas range, an outer wall of the pan ensures that the hot gas travels through a heat conduction channel (HCC) by redirecting gas that would otherwise travel horizontally outward away from the pan. A tapered shape of the heat conduction channel creates a lower opening large enough to capture gas from a broad range of focused heat source output levels. Low output energy results in a small volume of relatively slow-moving gas that is able to enter the heat conduction channel with good adhesion to the pan primary sidewall. High output energy generally results in a large volume of relatively fast-moving gas that is unable to maintain contact with the pan primary sidewall as it reaches the outer extent of the pan bottom. After the gas detaches from the pan bottom it is redirected into the conduction channel by the outer wall. Mid-range focused heat source output levels generally behave either similar to that of low output energy, high output energy, or a hybrid thereof.

A generally tapered shape of the conduction heat channel consolidates the gas into a form most appropriate for energy extraction. By reducing the volume of the conduction heat channel from a bottom to a top of the pan, the hot gas is forced into a ring shape, thereby increasing its surface area to volume ratio and enabling the heat surface area in contact with the outer and inner surfaces of the heat conduction channel to transfer the heat energy of the gas to the pan. In embodiments, the total area or size of the heat conduction channel can be optimized for maximum energy extraction, although consideration should be given to the applicability of a wide variety of direct and indirect heat source outputs. In some embodiments, the heat conduction channel can define a gap of between about 0.0625 inches to about 1.00 inches; although other gap widths are also contemplated.

In embodiments, the tapered shape of the heat conduction channel can play an important role in keeping the hot gas moving fast and vertically. As the hot gas transfers energy to the pan, it decreases in temperature. According to the ideal gas law, as a gas cools its density increases. In order to keep the gas moving (e.g., minimize its deceleration), the volume of the heat conduction channel should correspondingly decrease, thereby maintaining movement of the gas, and generally maximizing the convective heat transfer from gas to pan. The taper can continue to the upper extent of the pan, or in some embodiments can transition to a lesser or non-tapered section of the heat conduction channel.

The heat conduction channel upper exit nozzle can be unrestricted, such that the heat conduction channel modifies the flow of hot gas without restriction. Hot gas naturally rises, modifying the flow for maximum energy extraction enables an improved process window/input energy range. One such embodiment uses a constant width (non-tapered) section at the uppermost extent of the heat conduction channel to keep gas moving smoothly as it exits. By varying the height of the non-tapered section, the overall volume reduction of the heat conduction channel can be modified. In general, a longer non-tapered section decreases volume reduction, while a shorter non-tapered section increases volume reduction.

One goal of the heat conduction channel shape (and outer ring) is to maintain hot gas from a focused energy source moving upwards. According to the convective heat transfer equation, to increase heat transfer between two materials, the contact time, heat transfer area, or heat transfer constant must be increased. Embodiments of the present disclosure generally increase the heat transfer coefficient by increasing the contact area and by keeping the gas moving, such that the increased contact area is continually subjected to a fresh flow of hot gas. That is, the heat conduction channel and outer wall of the pan modify, but do not restrict, a flow of hot gas to keep it moving.

For the reasons mentioned above, volume reduction of the HCC (i.e. the difference in area between the exit nozzle and HCC average cross sectional area) can be such that energy extraction is maximized and impedance to gas flow minimized. One embodiment has an exit nozzle area equal to 72% the average HCC cross sectional area. Generally, a higher outlet to average HCC area ratio provides less restriction to gas flow. Given the desired taper of the HCC, there will usually be some reduction of area (or volume). Generally, an outlet area equal to at least 40% the average HCC cross sectional area, is desired. Some embodiments have an exit nozzle area equal to approximately 70% the average HCC cross sectional area, providing for a balanced cooking performance profile. Varying the degree of taper, exit nozzle shape/degree of taper, inlet shape, overall HCC shape, in addition to the overall shape of the HFFP (pan) itself allows for the modification of the outlet to average HCC area ratio. Outlet area ratios of 25% to 95% are considered, with 40% to 90% providing a balanced performance profile across various cooking settings.

Alternatively, the gas flow modification and flow restriction can be characterized by the gas exit area of the HCC relative to the total projected area of the high heat flux pan. The projected area can be described as the area encompassing a continuous outer perimeter of the high heat flux pan when viewed from a top or bottom planar view (including the HCC gas exit area). For example, one embodiment has a HCC exit area of 10 in² and a total projected area of 70 in². This gives a HCC gas exit area to projected area ratio of 1:7, or 14.3%. Other embodiments have ratios between 1% and 40%, with generally between 3-20% providing for a balanced performance profile across a variety of conditions.

In certain embodiments, the pour spouts, handles, and other features that extend beyond the outermost radial extent of the HCC, or other features that do not impact gas flow through the HCC are not be included in the projected perimeter calculation. Accordingly, utilizing outer perimeter in a projected perimeter calculation can be valuable because not all embodiments will be circular and the outer ring may not be continuous. Rather, embodiments of the calculation focuses on the area that is in the way of gas flow from below—what percentage of the area in the way of and/or blocking gas flow is the HCC exit.

Alternatively, the gas flow modification and flow restriction can be a function of the total volume of the HCC relative to the total volume of the high heat flux pan across the height of the HCC. For example, one embodiment has a total HCC volume of 28 in³ and a total volume across the same elevation as the HCC of 140 in³. This would provide a HCC volume to total volume ratio of 1:5 or 20%. Embodiments with ratios from 5% to 50% are considered, with 7 to 35% providing a balanced performance profile across a variety of conditions. In certain embodiments, the pour spouts, handles, and other features that extend beyond the outermost radial extent of the HCC, or other features that do not impact gas flow through the HCC are not be included in the projected perimeter calculation.

For the reasons mentioned above, volume reduction of the HCC (i.e. in HCC exit area and total HCC volume) can be such that energy extraction is maximized and impedance to gas flow minimized. One embodiment has an exit nozzle area equal to 36% the HCC total volume. Generally, a higher outlet to HCC volume ratio provides less restriction to gas flow. Given the desired taper of the HCC, there will usually be some reduction of area (or volume). Generally, an outlet area equal to at least 15% HCC total is desired. Some embodiments have an exit nozzle area equal to approximately 35% the HCC total volume, providing for a balanced cooking performance profile. Varying the degree of taper, exit nozzle shape/degree of taper, inlet shape, overall HCC shape, in addition to the overall shape of the HFFP (pan) itself allows for the modification of the outlet to HCC volume ratio. Outlet area ratios of 10% to 47% are considered, with 15% to 45% providing a balanced performance profile across various cooking settings. Specific relations are provided herein by way of illustration only and are not limiting. Other general relations are considered herein.

The continuous upwards flow is also important for the operation of the high heat flux pan over non-focused heat sources (NFHS) such as a grill, oven, or fire. In hot ambient environments and NFHS settings it is important to provide a free path through the heat conduction channel for gases. In a focused heat source (FHS) setting, the rising gas below is continuously pushing the gas above. By contrast, in the NFHS setting, gas must be free to flow with less restriction and compelled to enter and flow through the heat conduction channel. The tapered shape helps gas rising through the heat conduction channel to continue to rise rather than stall or sink as its density increases. Should there be minimal air/gas movement in a NFHS environment, such as an electric oven, hot gas may enter the heat conduction channel from above and exit below. The tapered shape is not particularly important in such environments, but the free path for gas is.

In embodiments, the outer ring can be constructed of a conductive material and attached to the primary pan body in a manner sufficient to provide efficient heat transfer from the outer ring to the pan body. It is desirous to transfer energy conducted from hot gas to the inner surface of the ring in both FHS and NFHS settings to the main pan body. In NFHS settings the outer surface of the ring functions as a conductor, thus it is important that the surface and profile of the outer ring is conducive to convective and conductive heat transfer from gas to self. One embodiment of an outer ring is in the form of a smooth, mostly vertical surface substantially free of modification except for relatively small features such as handles or pour spouts. Although, in some embodiments, the outer ring profile can be modified with heat conductive features such as fins or other surface area modifiers.

One embodiment of the present disclosure provides a cooking vessel configured to enable improved airflow around heating surfaces resulting in enhanced heating and cooking efficiency, the cooking vessel including a base defining a bottom surface representing a first heat conductive surface, an inner wall extending upwardly away from the base, the inner wall defining an outer surface representing a second heat conductive surface, and an outer wall at least partially surrounding the inner wall, the outer wall defining an inner surface representing a third heat conductive surface, wherein the bottom surface of the base defines at least one of a filleted or chamfered peripheral edge configured to promote adhesion of a flow of gas over the first and second heat conductive surfaces, wherein the second and third heat conductive surfaces cooperate to define a channel through which a flow of gas is directed, the channel being tapered along a length of the second and third heat conductive surfaces to promote a continuous flow of gas through the channel as the gas cools and decreases in volume, and wherein the second and third heat conductive surfaces further cooperate to define an exit nozzle having an area relative to a cross sectional area of the channel, the exit nozzle configured to enable the continuous flow of gas to exit the channel.

For example, the HCC volume can be defined as the void created by the second and third heat conducting surfaces. The average HCC cross sectional area can be defined as said volume divided by the average height of the HCC. In certain embodiments, average cross sectional area is desired because, for example, a curved inlet area can be unreasonable large if the radius is large, or potentially incalculable in the case of, for example, a wok. Accordingly, an exit nozzle area can be configured as a function of average HCC cross sectional area.

The overall size of the high heat flux pan can generally be characterized in terms of radius (for mostly circular embodiments), projected area, wall thickness, height, total volume, and mass. The high heat flux pan should fit into existing kitchens and cooking environments. Therefore, an average radius of 2-12 inches, projected area between 12 and 450 in², wall thickness between 0.03 and 0.75 inches, height of 0.25 to 18 inches, volume of 3 in³ to 8,100 in³, and mass between 0.125 and 20 lbm are generally possible, although further extremes are also possible. While other embodiments are considered, certain embodiments can have characteristics according to: an average radius: 3-8 inches; projected area: 25-200 in²; wall thickness: 0.05-0.25 inches; height: 1-6 inches; volume: 25 in3 to 1,600 in³; mass: 0.25-10 lbm. In certain embodiments, the pour spouts, handles, and other features that extend beyond the outermost radial extent of the HCC would not be included in radius or projected area characteristics. In one embodiment, the outer wall further defines an outer surface configured in at least one of a circular, oval, elliptical, square, rectangular, polygonal, or irregular shape. In one embodiment, the cooking vessel further comprises one or more handles. In one embodiment, the cooking vessel further comprises one or more pour spouts. In one embodiment, an upper vertical elevation gap is defined between the outer wall and the inner wall. In one embodiment, a lower vertical elevation gap is defined between the outer wall and the inner wall. In one embodiment, at least one of the inner wall or outer wall define one or more serrations configured to promote turbulence within the flow of gas. In one embodiment, both the inner wall and outer wall extend upwardly and at an acute or obtuse angle relative to the base. In one embodiment, the outer wall defines one or more connection points to establish contact for thermal conduction between the outer wall and the inner wall. In one embodiment, at least one of the inner wall or outer wall defines a non-uniform profile. In one embodiment, the channel is defined with an approximately circular profile proximal to a bottom edge of the channel and a polygonal profile proximal to a top edge of the channel.

Another embodiment of the present disclosure provides a cooking vessel including a base, an inner wall extending upwardly away from the base, and an outer wall at least partially surrounding the inner wall, wherein the base defines at least one of a filleted or chamfered peripheral edge, and wherein the inner and outer walls cooperate to define a tapered channel and an exit nozzle having a shallower taper than that of the tapered channel.

Yet another embodiment of the present disclosure provides a cooking vessel comprising: a base; an inner wall extending upwardly away from the base; and an outer wall at least partially surrounding the inner wall, wherein the base defines at least one of a filleted or chamfered peripheral edge, and wherein the inner and outer walls cooperate to define a tapered channel and an exit nozzle having an area relative to a cross sectional area of the tapered channel.

In embodiments, the second and third heat conductive surfaces further cooperate to define an exit nozzle having an area not less than 25% the average cross-sectional area of the entire channel.

Yet another embodiment of the present disclosure provides a cooking vessel configured to enable improved airflow around heating surfaces resulting in enhanced heating and cooking efficiency, the cooking vessel comprising: a base defining a bottom surface representing a first heat conductive surface; an inner wall extending upwardly away from the base, the inner wall defining an outer surface representing a second heat conductive surface; and an outer wall at least partially surrounding the inner wall operably coupled to at least one of the inner wall or base by one or more ribs, the outer wall defining an inner surface representing a third heat conductive surface, wherein the bottom surface of the base defines at least one of a filleted or chamfered peripheral edge configured to promote adhesion of a flow of gas over the first and second heat conductive surfaces, wherein the peripheral edge of the bottom surface of the base has a radius of between about 0.125 inches and about 1.50 inches, wherein the second and third heat conductive surfaces cooperate to define a channel through which a flow of gas is directed, the channel being tapered along a length of the second and third heat conductive surfaces to promote a continuous flow of gas through the channel as the gas cools and decreases in volume, wherein the channel has a taper angle measuring between about 5° and about 45°, wherein the second and third heat conductive surfaces further cooperate to define an exit nozzle having an area relative to a cross sectional area of the channel, the exit nozzle configured to enable the continuous flow of gas to exit the channel, wherein the exit nozzle has a taper angle measuring less than 15°, wherein the exit nozzle defines a peripheral gap measuring between about 0.0625 inches to about 1.00 inches.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a top perspective view depicting a high heat flux pan, in accordance with an embodiment of the disclosure.

FIG. 2 is a top plan view depicting the high heat flux pan of FIG. 1, in accordance with an embodiment of the disclosure.

FIG. 3 is a cross-sectional view depicting the high heat flux pan of FIG. 1 subjected to a focused heat source, in accordance with an embodiment of the disclosure.

FIG. 4 is a cross-sectional view depicting the high heat flux pan of FIG. 1 subjected to a non-focused heat source, in accordance with an embodiment of the disclosure.

FIG. 5 is a bottom perspective view depicting the high heat flux pan of FIG. 1, in accordance with an embodiment of the disclosure.

FIG. 6 is a bottom plan view depicting the high heat flux pan of FIG. 1, in accordance with an embodiment of the disclosure.

FIG. 7 is a perspective view depicting a high heat flux pan having a polygonal shape, in accordance with an embodiment of the disclosure.

FIG. 8 is a perspective view depicting a high heat flux pan having a substantially cylindrical base and a polygonal outer wall, in accordance with an embodiment of the disclosure.

FIG. 9 is a perspective view depicting a high heat flux pan having substantially parallel inner and outer walls, in accordance with an embodiment of the disclosure.

FIG. 10 is a cross-sectional view of the high heat flux pan of FIG. 9, in accordance with an embodiment of the disclosure.

FIG. 11 is a perspective view depicting a high heat flux pan having handles and pour spouts, in accordance with an embodiment of the disclosure.

FIG. 12 is a top plan view depicting the high heat flux pan of FIG. 11, in accordance with an embodiment of the disclosure.

FIG. 13 is a top perspective view depicting a high heat flux pan, in accordance with an embodiment of the disclosure.

FIG. 14 is a bottom perspective view depicting the high heat flux pan of FIG. 13, in accordance with an embodiment of the disclosure.

FIG. 15 is a top perspective view depicting a high heat flux pan, in accordance with an embodiment of the disclosure.

FIG. 16 is a bottom perspective view depicting the high heat flux pan of FIG. 15, in accordance with an embodiment of the disclosure.

FIG. 17 is a perspective view depicting a high heat flux pan with an outer wall defining an upper vertical elevation gap, in accordance with an embodiment of the disclosure.

FIG. 18 is a perspective view depicting a high heat flux pan with an outer wall defining a lower vertical elevation gap, in accordance with an embodiment of the disclosure.

FIG. 19 is a perspective view depicting a high heat flux pan with an outer wall defining one or more a plurality of serrations, in accordance with an embodiment of the disclosure.

FIG. 20 is a perspective view depicting a high heat flux pan wherein both an inner wall and an outer wall are angled relative to a base, in accordance with an embodiment of the disclosure.

FIG. 21 is a cross-sectional view depicting the high heat flux pan of FIG. 19, in accordance with an embodiment of the disclosure.

FIG. 22 is a perspective view depicting a high heat flux pan in which an outer wall merges with an inner wall in four areas, in accordance with an embodiment of the disclosure.

FIG. 23 is a top plan view depicting the high heat flux pan of FIG. 22, in accordance with an embodiment of the disclosure.

FIG. 24 is a perspective view depicting a high heat flux pan in which an outer wall merges with an inner wall in eight areas, in accordance with an embodiment of the disclosure.

FIG. 25 is a top plan view depicting the high heat flux pan of FIG. 24, in accordance with an embodiment of the disclosure.

FIG. 26 is a cutaway perspective view depicting a high heat flux pan in which an inner wall defines a heat conducting channel of a non-uniform profile, in accordance with an embodiment of the disclosure.

FIG. 27 is a perspective view depicting a high heat flux pan having a chamfered transition between a base and an inner wall, in accordance with an embodiment of the disclosure.

FIG. 28 is a cross-sectional view depicting the high heat flux pan of FIG. 27, in accordance with an embodiment of the disclosure.

FIG. 29 is a perspective view of a high heat flux pan having a rectangular shape, in accordance with an embodiment of the disclosure.

FIG. 30A is a graphical representation comparing the heat flux for a high heat flux pan to a conventional pan when subjected to a focused heat source, in accordance with an embodiment of the disclosure.

FIG. 30B is a graphical representation comparing the heat flux for a high heat flux pan to a conventional pan when subjected to a non-focused heat source, in accordance with an embodiment of the disclosure.

FIG. 31A is a graphical representation comparing the temperature of a high heat flux pan to a conventional pan when subjected to a focused heat source from a gas stove, in accordance with an embodiment of the disclosure.

FIG. 31B is a graphical representation comparing the temperature of a high heat flux pan to a conventional pan when subjected to a semi-focused heat source from a gas grill, in accordance with an embodiment of the disclosure.

FIG. 31C is a graphical representation comparing the temperature of a high heat flux pan to a conventional pan when subjected to a non-focused heat source from a gas oven, in accordance with an embodiment of the disclosure.

FIG. 32A is a graphical finite element analysis of temperatures and gas flows related to a high heat flux pan subjected to a focused heat source, in accordance with an embodiment of the disclosure.

FIG. 32B is a graphical finite element analysis of temperatures and gas flows related to a conventional pan subjected to a focused heat source.

FIG. 33A is a graphical finite element analysis of the velocity of gas surrounding a high heat flux pan subjected to a focused heat source, in accordance with an embodiment of the disclosure.

FIG. 33B is a graphical finite element analysis of the velocity of gas surrounding a conventional pan subjected to a focused heat source.

FIG. 34A is a graphical finite element analysis of temperatures and gas flows related to a high heat flux pan subjected to a non-focused heat source, in accordance with an embodiment of the disclosure.

FIG. 34B is a graphical finite element analysis of temperatures and gas flows related to a conventional pan subjected to a non-focused heat source.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

With cast iron pans, traditional methods of searing food rely on a transfer of thermal energy stored within the cast iron pan to the food. Unfortunately, this method only works for a finite amount of time, as eventually the thermal energy stored within the cast-iron pan is depleted. Specifically, once excess heat is transferred to the food, heat flux in the pan moves from time dependent to steady state. Once in steady state, only energy from the heat source will move to the food. For example, an initial side of the food will sear well but subsequent sides will be subjected to lower temperatures and lesser sear. This phenomenon increases in prevalence until the amount of energy leaving the pan is equal to the amount coming in. Additionally, by using this stored energy searing method, food (at least initially) can be subjected to a much higher temperature than ideal for proper searing/caramelization.

Over the years, various types of cookware have been developed in an attempt to produce more energy-efficient heating surfaces, designed to transfer as much energy from the heat source to the food being heated in steady state conditions, with less emphasis on retention of heat energy within the cookware itself. For example, U.S. Pat. No. 9,516,967, the contents of which are incorporated by reference herein to the extent that they do not contradict the teachings herein, teaches a heating vessel having a plurality of radially extending ribs in an attempt to increase a surface area in contact with hot gases. Other cooking vessels, such as those disclosed in U.S. Pat. Nos. 4,646,717; 5,373,836 and 8,020,550, the contents of which are incorporated by reference herein to the extent that they do not contradict the teachings herein, teach surrounding skirts or walls which attempt to trap hot gases around the vessel, rather than to enable a continuous, steady-state flow of hot gases by heating surfaces.

Thus, although in theory these various attempts to produce more energy efficient heating surfaces through the use of radially extending ribs and surrounding skirts may generally improve energy efficiency where the input energy is direct, known and constant, the resultant cookware would not be suitable in other situations; particularly where the heat energy is not constant or is indirect, like that of a grill, open fire, oven or the like. Moreover, these attempts are not designed to guide a flow of gas over the heating surfaces in a manner that considers the ideal gas law in the transfer of thermal energy from the heat source to the cookware. It is further noted that generally cooking vessels of the prior art which attempt to produce more energy-efficient heating surfaces are very complex, making them both difficult to use (e.g., too large or heavy to be used in the home, difficult to clean, etc.) and impractical to produce.

By contrast, embodiments of the present disclosure are configured to keep gasses moving smoothly and quickly with a radius on the bottom edge of the pan, a tapered heat conduction channel to inhibit cooled (denser) gas from slowing down, and a gas channel exit/top to enable the gas to freely be exhausted or exit. Keeping the gas moving using the aforementioned features is beneficial, as it enables the vessel to operate with variable input energies.

Moreover, embodiments of the present disclosure can be easily cast, machined, or formed as a single unitary body; although the use of multiple, simple bodies joined with standard joining methods such as welding or riveting is also contemplated. Being of such a simple design, embodiments of the present disclosure are typically only slightly heavier and larger than a comparable conventional pan, leading to easy acceptance into an existing kitchen or use in outdoor cooking environments. Accordingly, embodiments of the present disclosure enable a smooth, uninterrupted flow of gas while enabling ease in access while cleaning.

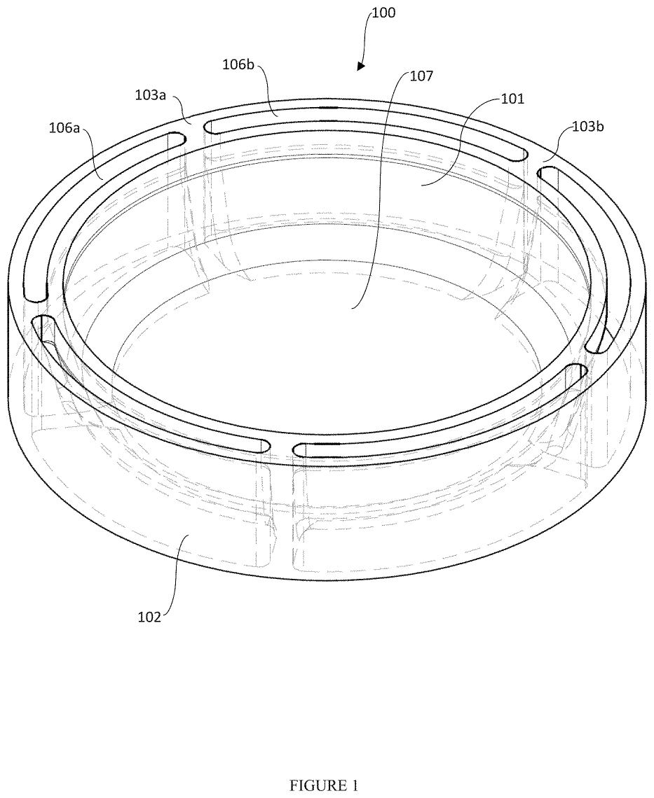

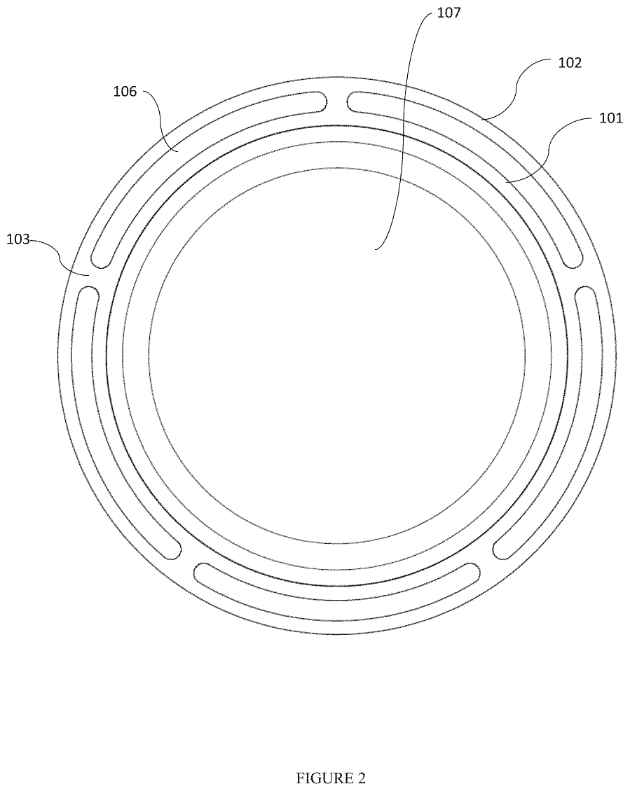

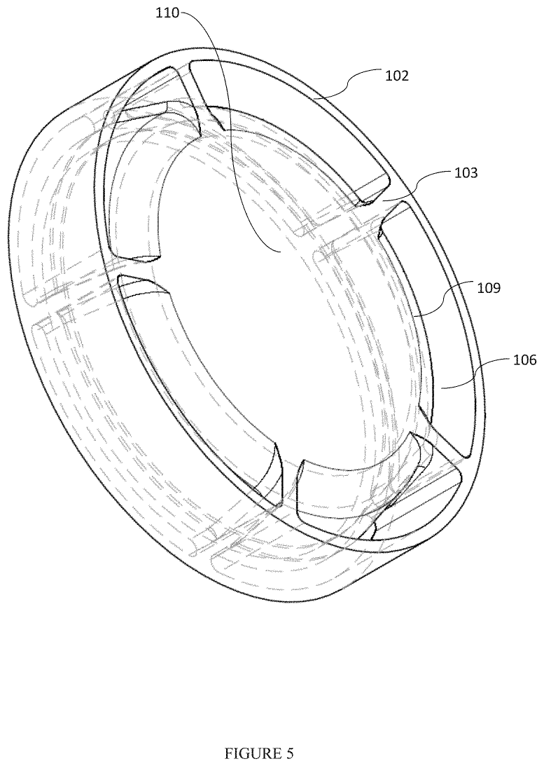

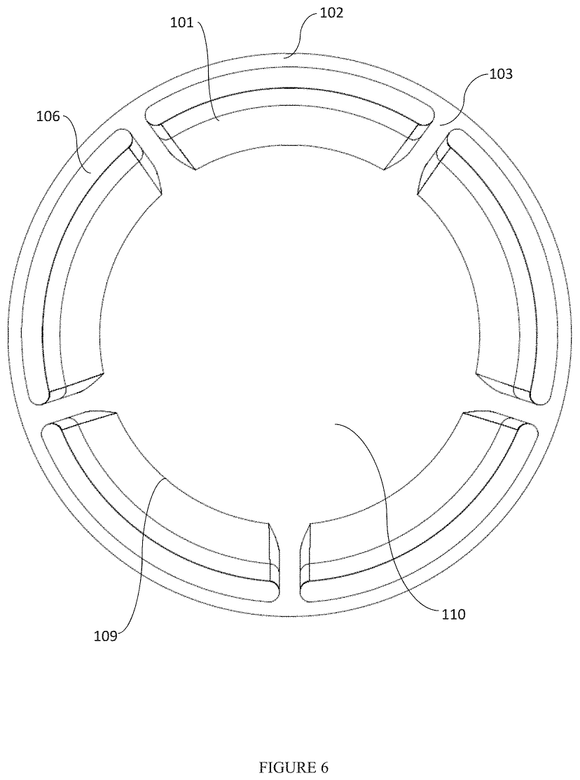

Referring to FIGS. 1-6, a high heat flux pan 100 is depicted in accordance with an embodiment of the disclosure. In this embodiment, the high heat flux pan 100 includes a substantially circular base 107 with an internal heating wall 101 extending generally perpendicular to the base 107, and a second wall 102 extending generally parallel to the internal heating wall 101. In this embodiment, the second wall 102 can generally have a uniform cylindrical profile with an uppermost vertical extent approximately equal in elevation to the top of the internal heating wall 101 and lowermost vertical extent approximately equal in elevation to the bottom of the circular base 107. The internal heating wall 101 and the second wall 102 can be connected with a plurality of integrally formed ribs 103 extending radially from the internal heating wall 101 and contacting the second wall 102. The bottom of the base 107 can be generally planar or flat, but can also be curved (e.g., such as a wok) or otherwise shaped.

In embodiments, the internal heating wall 101 and second wall 102 can define a void, alternatively referred to as heat conduction channels 106a, 106b, thereby enabling passageway for the control and use of hot gases H proximal to the pan 100. Accordingly, the internal heating wall 101 and second wall 102 direct hot gases H coming from an energy source E into the heat conduction channels 106 that would otherwise escape into the atmosphere.

An internal heating wall 101 and second wall 102 extending vertically and generally parallel to one another represents one example form or embodiment of a heat conduction channel arrangement. As the shape of the walls 101, 102 and heat conduction channels 106 have a large influence on the heat transfer properties of the high heat flux pan 100, other embodiments are also contemplated wherein like reference numerals represent like parts and assemblies throughout the several views.

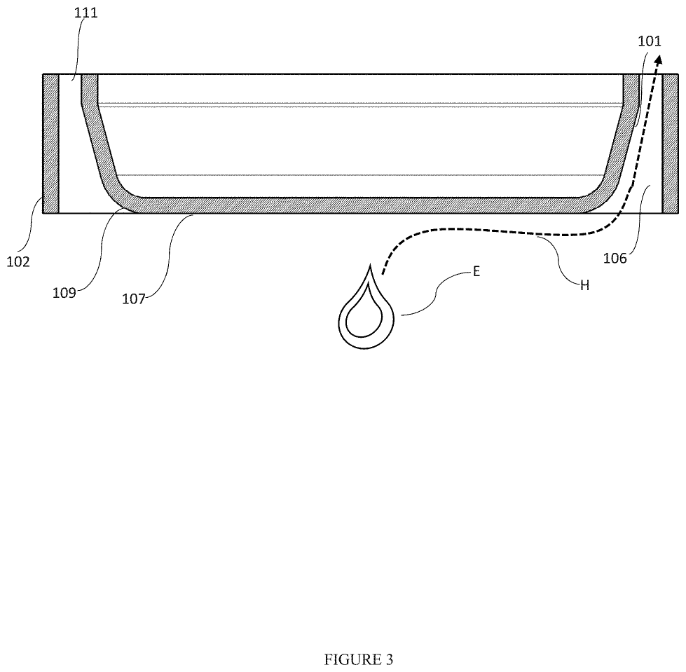

As best depicted in FIG. 3, when subjected to direct heat, gas H leaving a FHS (such as a gas stove) travels vertically before hitting the base 107. Upon hitting the base 107, the flow of hot gas turns approximately 90° and travels parallel to the base 107. Once the flow of gas H reaches the outside edge of the base 107, it is generally unfavorable to disrupt the adhesion of the gas H to the pan 100 with another sharp turn. Accordingly, in some embodiments, a peripheral edge 109 of the base 107 can be filleted or rounded, thereby easing a change in direction of the flow of hot gas H so as to create better adhesion of the flow of gas H to the heating surfaces of the pan 100. For example, in some embodiments, the peripheral edge 109 can have a radius of about 0.750 inches. In other embodiments, the peripheral edge 109 can have a radius of between about 0.125 inches and about 1.50 inches, to enable the gas H to hug the pan 100 and move from a horizontal path along the bottom of the base 107 to a (substantially) vertical path along the interior heating wall 101.

The second wall 102 serves to guide the flow of hot gas H into the heat conduction channels 106, and to approximately double (and in the case of NFHS approximately triple) the heating surfaces of the pan 100. Accordingly, as the flow of hot gas H rounds the peripheral edge 109 of the base 107, the gas travels along the interior heating wall 101 and second wall 102, thereby transferring energy to their respective surfaces.

As the hot gas H transfers its thermal energy to the pan 100, the gas cools and its density increases according to the ideal gas law, such that the overall volume of hot gas H decreases as it travels upward along the heating walls 101, 102. With a goal of the inhibiting cooled (denser) gas from slowing down as it travels along the walls 101, 102, in embodiments, the heat conduction channels 106 can decrease in width towards a top of the pan 100. In other words, the channels 106 can taper, thereby maintaining a desired velocity of the hot gas H as its density increases, thereby maintaining a consistent rate of flow of gas along the heating surfaces.

In certain embodiments, heating wall 102 further comprises an outer surface representing a fourth heat conductive surface. In contrast to insulated outside surfaces, embodiments of the fourth heat conductive surface can further improve heat transfer.

In some embodiments, the pan 100 can further include a section of the channel 106 representing a non-tapered heat conduction channel 111 in proximity to a top of the pan 100, configured to serve as an exit nozzle for the hot gas H. For example, a non-tapered heat conduction channel 111 having a width of about 0.375 inches can provide heat transfer improvement over a variety of fluid flow conditions; although a larger or smaller gap ranging from between about 0.0625 inches to about 1.00 inches is also contemplated, with larger gaps generally providing greater benefit over high powered energy sources.

In other embodiments, the taper of the channel 106 can continue, but at a shallower angle than other portions of the taper, or in other embodiments, relative to an area of the channel. For example, in some embodiments, the channel 106 can shallow to about 15°, with an exit nozzle tapering further, which represents a good balance between practicality and performance. Larger or smaller final taper angles of section 111 between about 0° and about 90° have been found to also provide a performance benefit.

In some embodiments, non-tapered heat conduction channel 111 provides a gas exit nozzle area equal to approximately 70% the average cross-sectional area of the void between inner wall 101 and outer wall 102, thereby providing balanced performance across a range of cooking environments. In other embodiments, the area ratio will vary with the overall shape of the heat conduction channel and pan itself.

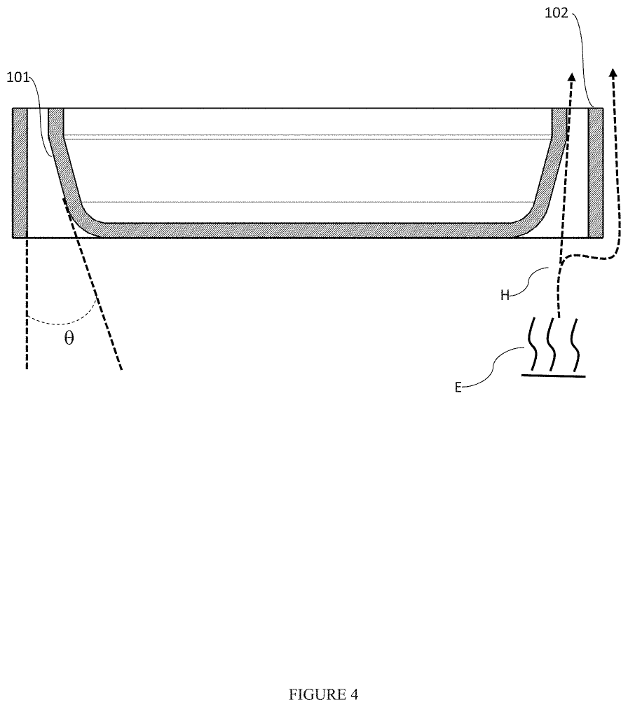

In addition to improving heat transfer and guided flow of hot gases in FHS (e.g., a gas range), the high heat flux pan 100 is also well adapted for NFHS (e.g., a grill, open fire, oven or the like). As depicted in FIG. 4, where the energy source E is not concentrated underneath the pan 100, but distributed throughout the ambient environment, the hot gas H travels over the outer radial extent of second wall 102 in addition to the inner radial extent of second wall 102 and internal heating wall 101. This creates three primary conduction surfaces, including an outer radial extent of the internal heating wall 101, an inner radial extent of outer wall 102, and an outer radial extent of outer wall 102. In certain embodiments, a fourth primary conduction surface is created by a lower vertical extent of base 107.

In embodiments, the second wall 102 is connected to the pan base 107 and/or inner heating wall 101 in order to provide a low resistance transfer of heat energy from the exterior surfaces of the second wall 102 into the inner heating wall 101 and pan base 107. In some embodiments, the low resistance connection is provided with a plurality of ribs 103 operably coupling the second wall 102 to other portions of the pan 100 (e.g., inner wall 101 or pan base 107). In embodiments, the ribs 103 may or may not run a full vertical length of the pan 100, although in some embodiments each of the ribs 103 cross-sectional area is maximized to obtain low resistance heat transfer from the second wall 102 to the inner heating wall 101/base 107.

In embodiments, maximization of each of the ribs 103 cross-sectional area does not necessarily require ribs 103 extending fully from the top or bottom, but rather in order to maximize area while minimizing width, one or more ribs 103 can extend the whole vertical length. For example, Area=Length*Width so to keep W low, L will be high.

In order to inhibit disruption of the flow of hot gas H through the heat conduction channels 106, in some embodiments, the ribs 103 can generally have a taller and thinner cross-sectional area. In some embodiments, a total of five ribs 103 represent a good balance between conduction and airflow capacity; although the use of a greater or lesser number of ribs 103 is also contemplated.

It will be appreciated in the description of alternative embodiments that ribs 103 are not the only method of connecting the inner wall 101 and outer wall 102/base 107. Any structure that creates good thermal contact between the inner wall 101 and outer wall 102/base 107 can provide low resistance conduction. Moreover, the second wall 102 does not need to be formed with the inner wall 101 as a unitary component. Rather, the second wall 102 can be a separate body fastened, welded, or otherwise connected to, and in good thermal contact with, the inner wall 101 and/or ban base 107.

Accordingly, embodiments of the present disclosure provide a high heat flux pan 100 defining one or more heat conduction channels 106 including a tapered shape from bottom to top of angle θ (where the top is narrower than bottom), a radius between about 0.125 and about 2.00 inches along a peripheral edge 109 of base 107 (e.g., representing a smooth curve from horizontal bottom or base 107 to vertical side wall 101), and gas channel section 111, having an area equal to between 25% and 95% the average HCC cross sectional area, providing for the free flow and exit of hot gas from the HCC 106. Accordingly, embodiments of the present disclosure provide a pan 100 with increased heat transfer qualities, thereby enabling the pan 102 to maintain a desired temperature while rapidly delivering energy to food. Accordingly, transferring a steady-state supply of heat (e.g., without relying on a transfer of built-up energy stored within the pan) enables searing of food with less burn/char and more caramelization/sear.

Thus, one advantage provided by the high heat flux pan 100 is the ability of the pan 100 is an increase in the pan's absorption of thermal energy from a heat source from an increased surface area combined with superior conductivity from the control of hot gases proximal to the pan. Moreover, the high heat flux pan 100 is useful in a wide variety of environments and for a wide variety of functions, including searing food at high temperature, cooking food on a gas, charcoal, or otherwise fueled grill, or over an open fire, and baking food in an oven.

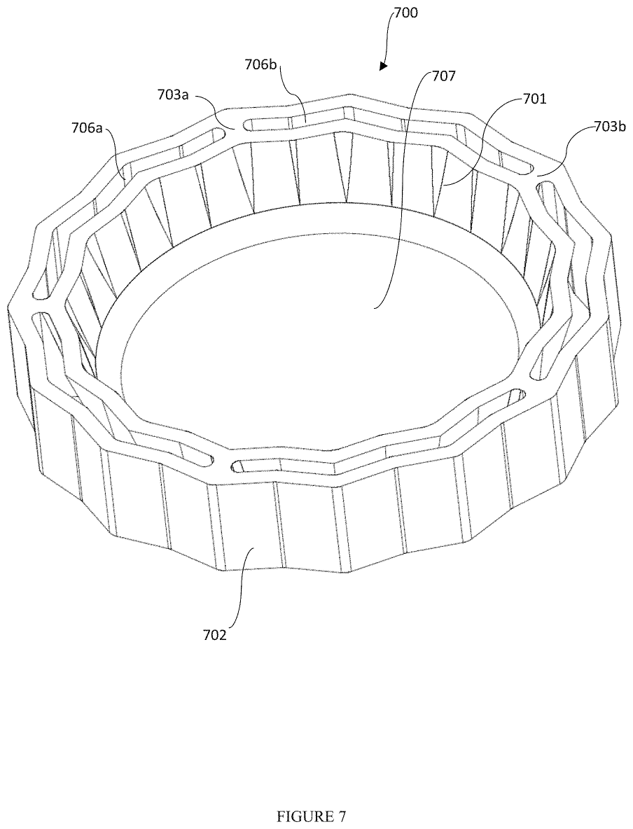

Although the overall shape of the pan 100 as depicted in FIGS. 1-6 is substantially circular, other embodiments can be oval, elliptical, polygonal or irregular in shape (non-inclusive). For example, with reference to FIG. 7, a polygonal shaped high heat flux pan 700 is depicted in accordance with an embodiment of the disclosure. In this embodiment, the pan 700 includes a base 707 with a polygonal shaped internal heating wall 701 extending generally perpendicular to the base 707, with a polygonal shaped second wall 702 extending generally parallel to the internal heating wall 701. In this embodiment, the internal heating wall 701 and second wall 702 can be connected with a plurality of integrally formed ribs 703a, 703b. A void defined between the internal heating wall 701 and second wall 702 defined heat conduction channels 706, representing a passageway for control and use of hot gases proximal to the pan 700. Accordingly, in embodiments, the internal heating wall 701 and second wall 702 can be configured to direct hot gases coming from an energy source into the heat conduction channels 706 that would normally escape into the atmosphere.

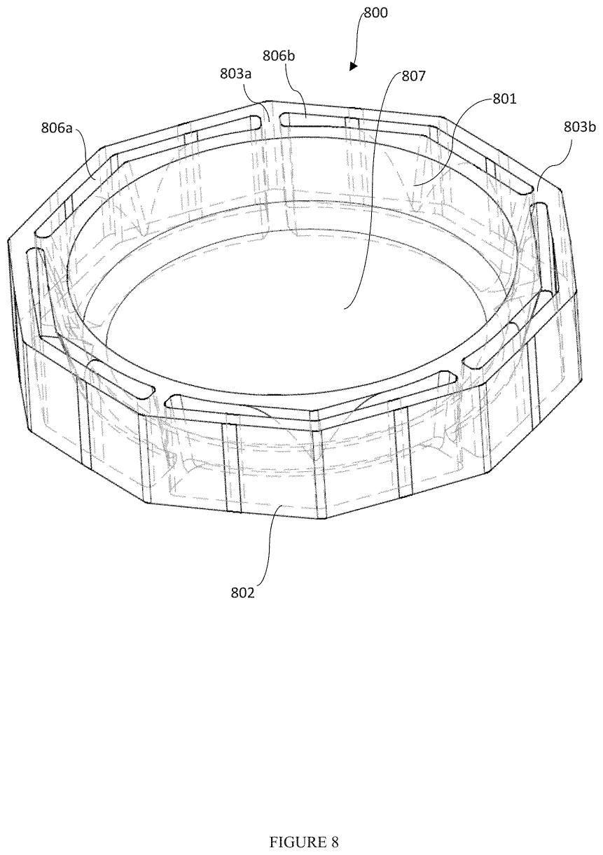

With reference to FIG. 8, polygonal shaped high heat flux pan 800 having a substantially round or circular cooking base is depicted in accordance with an embodiment of the disclosure. In this embodiment, the pan 800 can have a base 807, polygonal shaped inner wall 801, polygonal outer wall 802, integrally formed ribs 803, and heat conduction channels 806. In this embodiment, the second wall 802 may or may not be vertical.

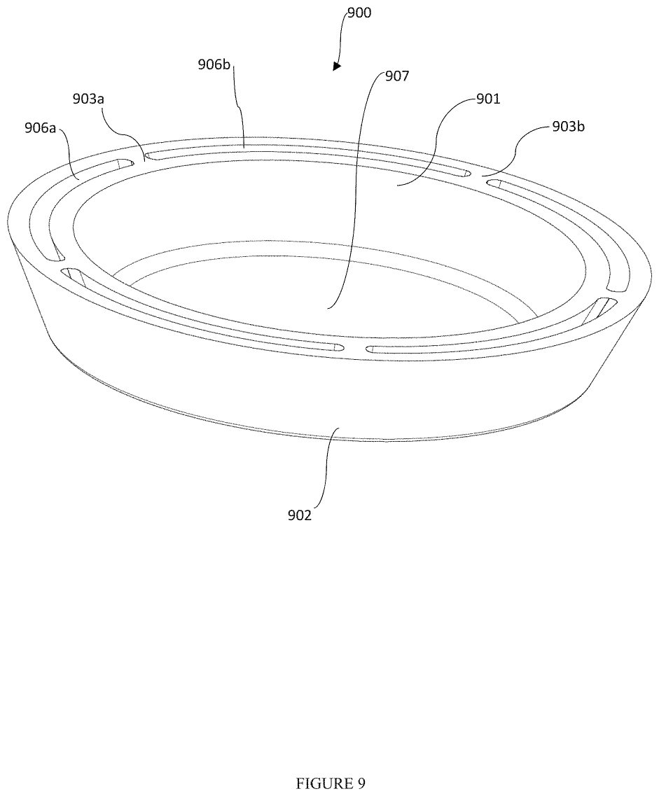

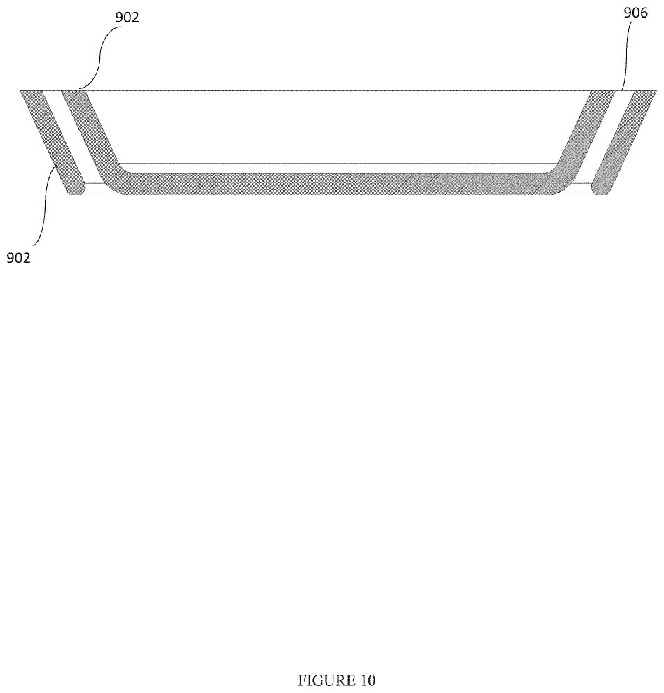

In some embodiments, the inner and outer walls of the pan can be substantially parallel to one another (e.g., without a taper). For example, with reference to FIGS. 9-10, a circular shaped high heat flux pan 900 having no relative taper between internal heating wall 901 and second wall 902, thereby creating heat conduction channels 906 of constant width is depicted in accordance with an embodiment of the disclosure. In this embodiment, the pan 900 can include a base 907 with an internal heating wall 901 extending generally perpendicular therefrom and second wall 902 extending generally parallel to the internal heating wall 902. The internal heating wall 901 and the second wall 902 can be connected with a plurality of integrally formed ribs 903.

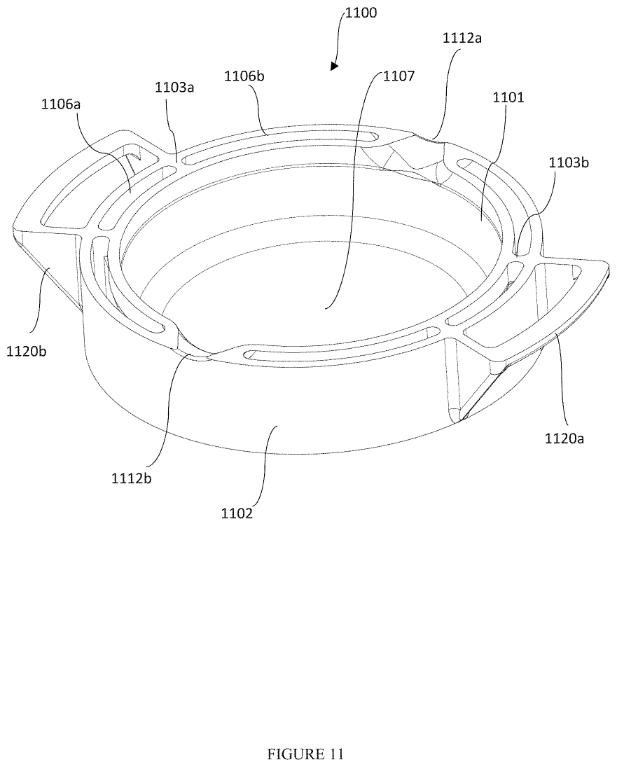

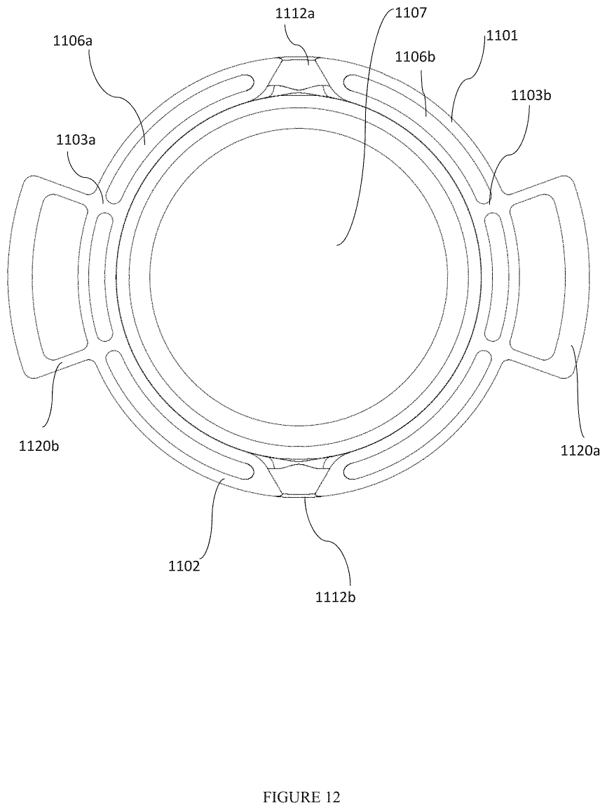

In some embodiments, the pan can include one or more handles enabling ease in maneuverability, as well as one or more pour spouts to aid in emptying food from the pan. For example, with reference to FIGS. 11-12, a pan 1100 having handles 1120a-b and pour spouts 1112a-b is depicted in accordance with an embodiment of the disclosure. In this embodiment, the pan 1100 can include a base 1107 with an internal heating wall 1101 extending generally perpendicular therefrom and second wall 1102 extending generally parallel to the internal heating wall 1102. A void can be defined between internal heating wall 1101 and second wall 1102 can define heat conduction channels 1106. Handles 1120, which can be integrally formed on the second wall 1102, can continue radially inwards to form ribs 1103 which can connect outer wall 1102 to the internal heating wall 1101 or base 1107. Pour spouts 1112, which can be formed integrally on both internal heating wall 1101 and second wall 1102, can serve to facilitate removal of liquids from the pan base 1107. In some embodiments, the pour spouts 1112 can concurrently serve as a conduction point for second wall 1102 to inner heating wall 1101, similarly to integral ribs 1103. As the pour spouts 1112 can generally disrupt a continuity of the second wall 1102 and heat conduction channels 1106, the integral ribs 1103 need not be equally spaced around a perimeter of the pan 1100. In some embodiments, the handle or handles 1120 can be formed integrally with the rest of the pan 1100. In other embodiments, the handle or handles 1120 can be mechanically fastened to the pan base 1107, the inner heating wall 1101, the second wall 1102, or a combination thereof. In some embodiments, the second wall 1102 need not be connected with ribs 1103 running the entire length of the internal heating wall 1101.

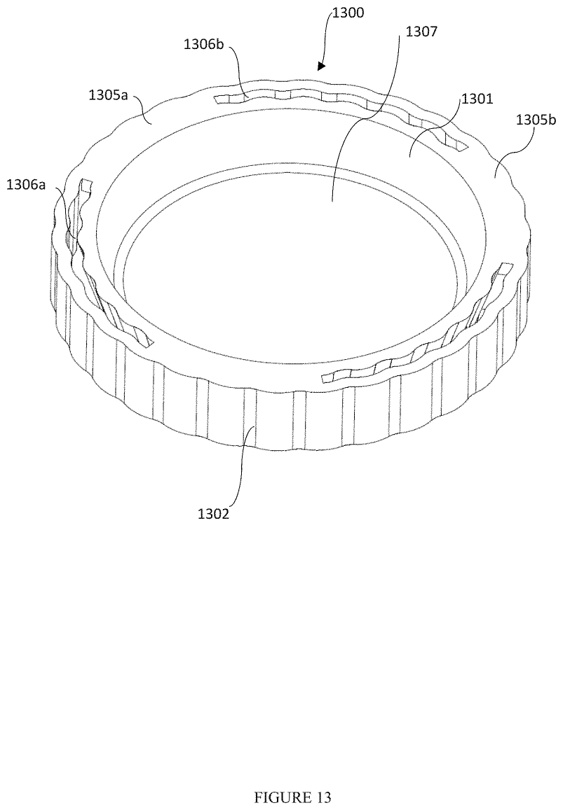

Referring to FIGS. 13-14, another embodiment of a high heat flux pan 1300 is depicted in accordance with the disclosure. In this embodiment, the pan 1300 can include a base 1307 with an internal heating wall 1301 extending generally perpendicular from the base 1307, and second wall 1302 extending generally parallel to the internal heating wall 1302. A void can be defined between internal heating wall 1301 and second wall 1302 to define one or more heat conduction channels 1306. In embodiments, the second wall 1302 and internal heating wall 1301 can be joined at one or more connection points 1305 to establish contact for thermal conduction from second wall 1302 to internal heating wall 1301. One or more ribs 1303 can be added below the connection points 1305 to further increase thermal conductivity.

In embodiments, the second wall 1302 can be integrally formed with the pan 1300 as a unitary member, or can be connected to the internal heating wall 1301 and/or base 1307 with mechanical fasteners such as rivets or screws at various points about its perimeter. The ribs 1303 and/or connection points 1305 can be replaced with another structure to connect structures. Ribs 1303 are preferred for their simplicity, but by no means are the only way to connect the second wall 1302 to the inner heating wall 1301 and/or pan base 1307.

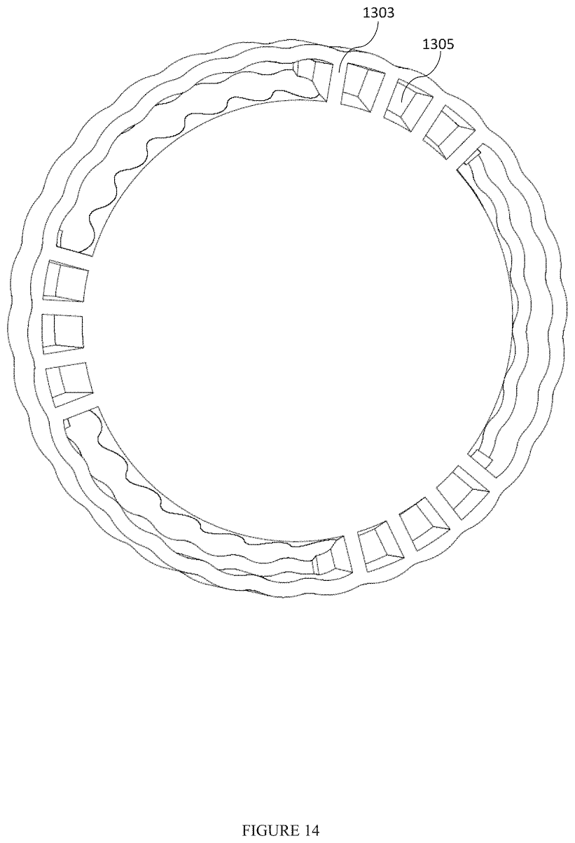

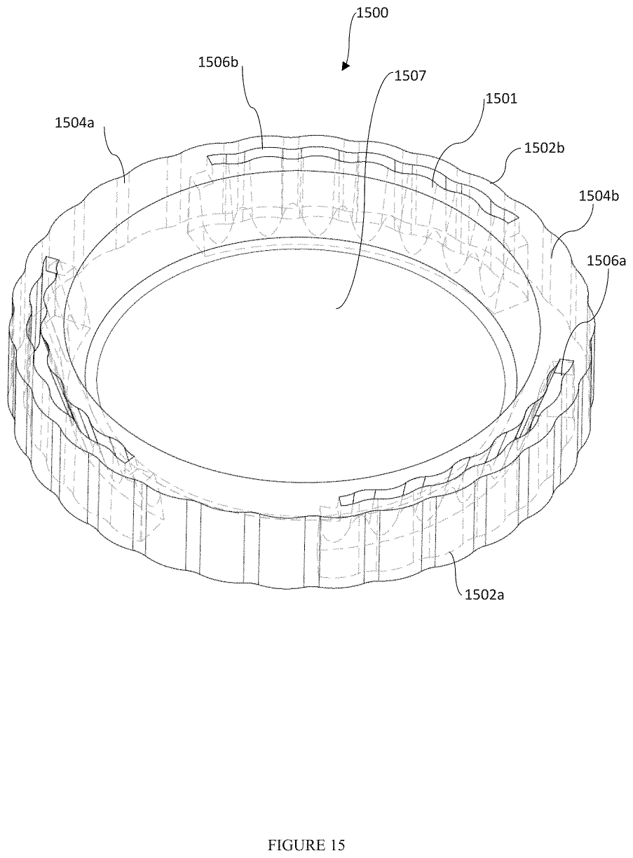

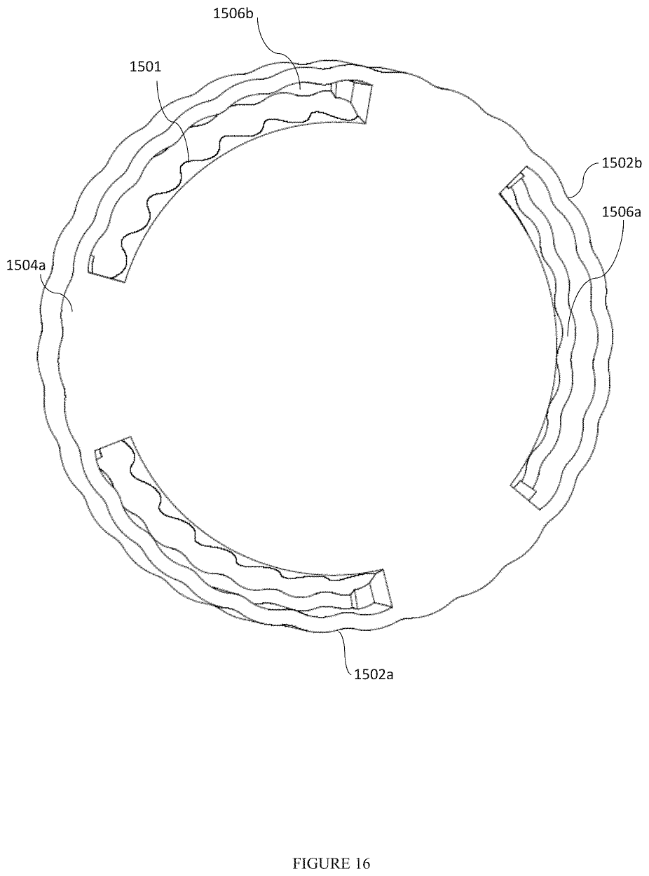

Referring to FIGS. 15-16, another embodiment of a high heat flux pan 1500 is depicted in accordance with the disclosure. In this embodiment, the pan base 1507 can define heat conduction channels 1506 around its perimeter to form internal heating walls 1501 extending generally perpendicular from base 1507, with the second walls 1502 extending generally parallel to the internal heating walls 1501. In embodiments, one or more connection points 1504 can serve as conduction media for heat transfer between the outer walls 1502 and inner walls 1501 and/or base 1507. In embodiments, the second wall 1502 may or may not be the same height as the internal heating wall 1501.

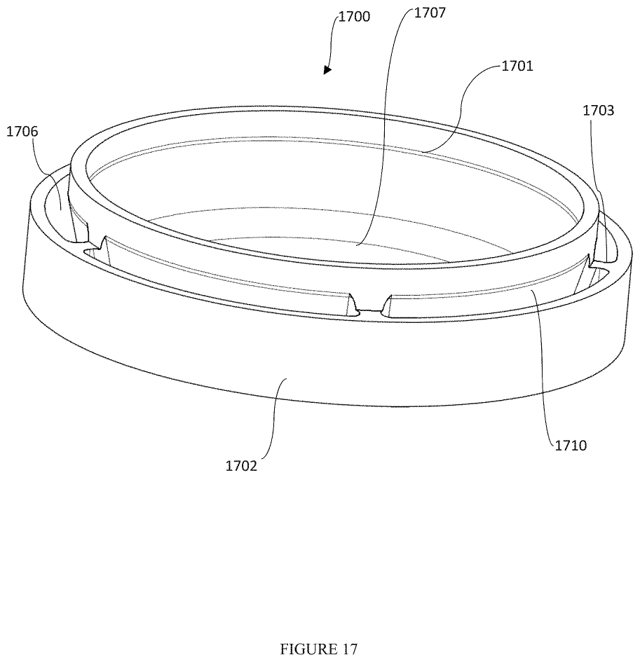

In some embodiments, the outer wall can have a lower profile than the inner wall. For example, referring to FIG. 17, a high heat flux pan 1700 having a shortened second wall 1702 is depicted in accordance with an embodiment of the disclosure. In this embodiment, the pan 1700 can include a base 1707 with an internal heating wall 1701 extending generally perpendicular to the base 1707, and second wall 1702 extending generally parallel to the internal heating wall 1702. A void can be defined between the internal heating wall 1701 and second wall 1702 to define one or more heat conduction channels 1706. In embodiments, the internal heating wall 1701 and the second wall 1702 can be connected with a plurality of integrally formed ribs 1703. In embodiments, the second wall 1702 and internal heating wall 1701 can share a lower vertical elevation, with the second wall 1702 upper vertical elevation generally being shorter than the internal heating wall 1701, thus defining an upper vertical elevation gap 1710.

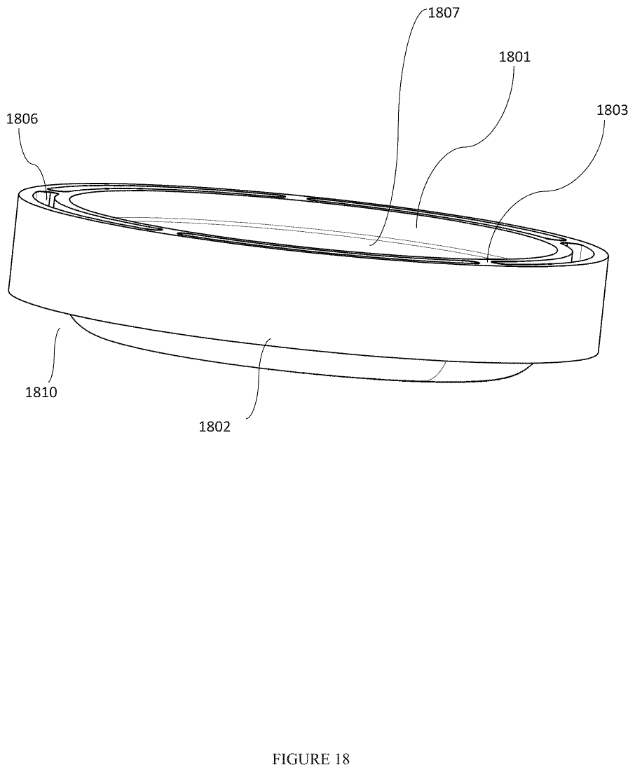

Referring to FIG. 18, a high heat flux pan 1800 having an alternative version of a shortened second wall 1802 is depicted in accordance with an embodiment of the disclosure. In this embodiment, the pan 1800 can include a base 1807 with an internal heating wall 1801 extending generally perpendicular to the base 1807, and second wall 1802 extending generally parallel to the internal heating wall 1802. A void can be defined between the internal heating wall 1801 and second wall 1802 to define heat conduction channels 1806. In embodiments, the internal heating wall 1801 and the second wall 1802 can be connected with a plurality of integrally formed ribs 1803. In embodiments, the second wall 1802 and internal heating wall 1801 share a similar upper vertical elevation, with the second wall 1802 lower vertical elevation generally being shorter than the internal heating wall 1801, thus defining a lower vertical elevation gap 1810.

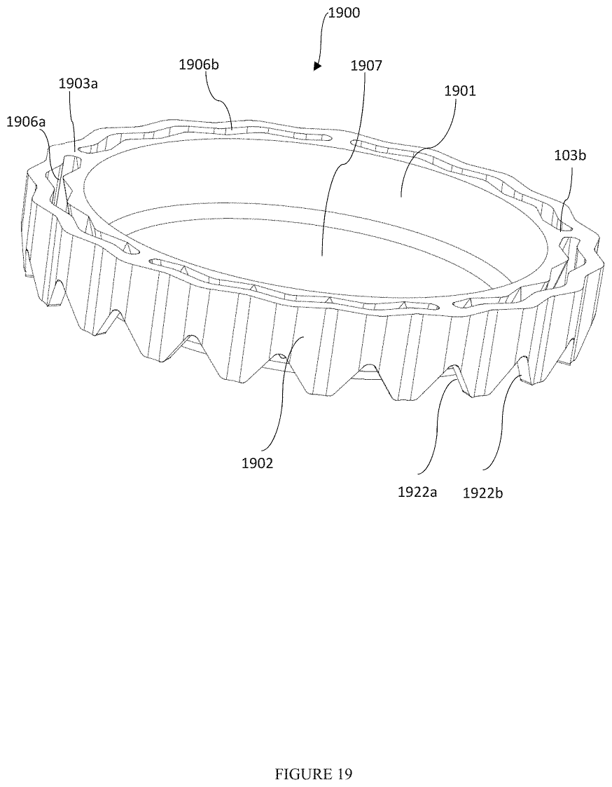

In some embodiments, the high heat flux pan can include one or more serrations to create turbulent airflow for improved heat transfer. For example, with reference to FIG. 19, a high heat flux pan 1900 including one or more serrations 1922a-b is depicted in accordance with an embodiment of the disclosure. In this embodiment, pan 1900 can include a base 1907 with an internal heating wall 1901 extending generally perpendicular to the base 1907, and second wall 1902 extending generally parallel to the internal heating wall 1902. A void can be defined between the internal heating wall 1901 and the second wall 1902 to define one or more heat conduction channels 1906. In embodiments, the internal heating wall 1901 and the second wall 1902 can be connected with a plurality of integrally formed ribs 1903. In embodiments, the lower vertical extent of second wall 1902 can include serrations 1922 spaced (e.g., approximately equally) around a perimeter of second wall 1902. In embodiments, the serrations 1922 can be configured to promote turbulent airflow around second wall 1902, leading to improved thermal heat transfer in certain ambient conditions.

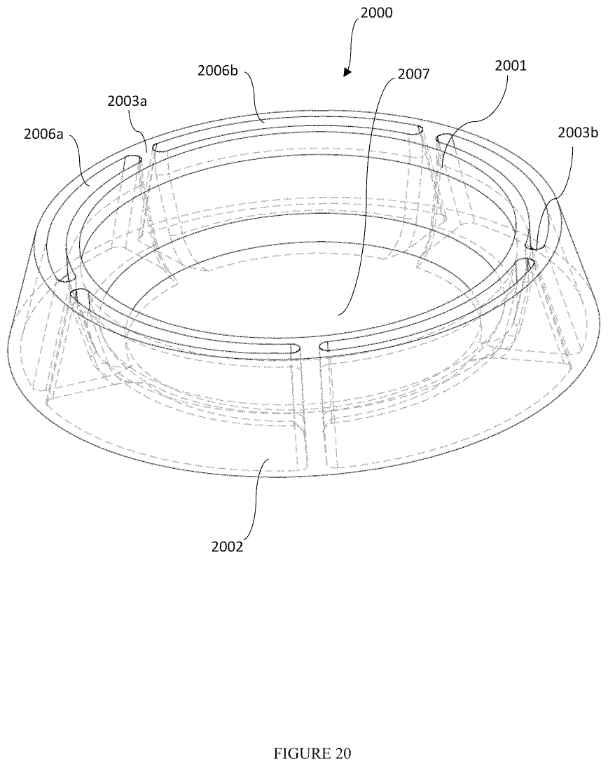

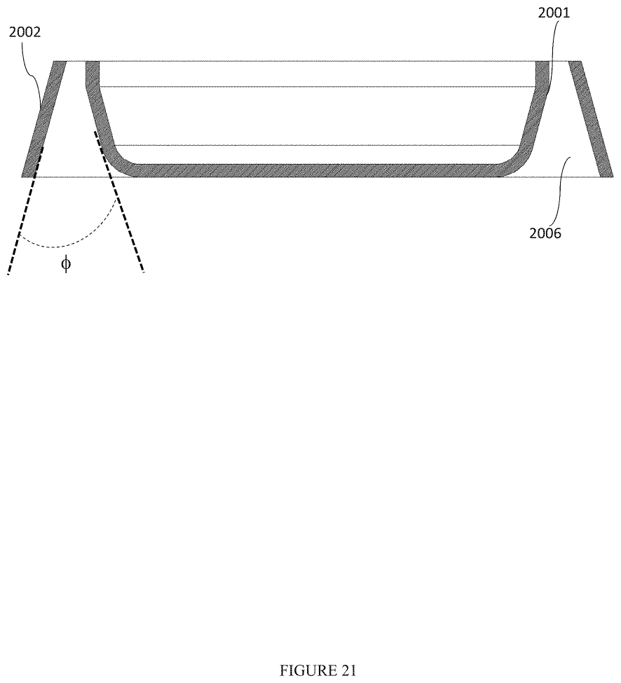

In some embodiments, the high heat flux pan can include both an angled inner wall an angled outer wall. For example, with reference to FIGS. 20-21, a high heat flux pan 2000 with an angled internal heating wall 2001 and angled second wall 2002, relative to base 2007, is depicted in accordance with an embodiment of the disclosure. In embodiments, walls 2001, 2002 can define one or more heat conduction channels 2006. In embodiments, the internal heating wall 2001 and the second wall 2002 can be connected with a plurality of integrally formed ribs 2003. In embodiments, a lower edge of second wall 2002 can have an outer radial extent greater than the top edge of second wall 2002, thus creating highly tapered heat conduction channels 2006 with angle ϕ. In embodiments, the highly tapered shape enables for a greater hot gas flux through the heat conduction channels 2006, while increasing the overall diameter of the cooking pan 2000 for improved stability on uneven surfaces.

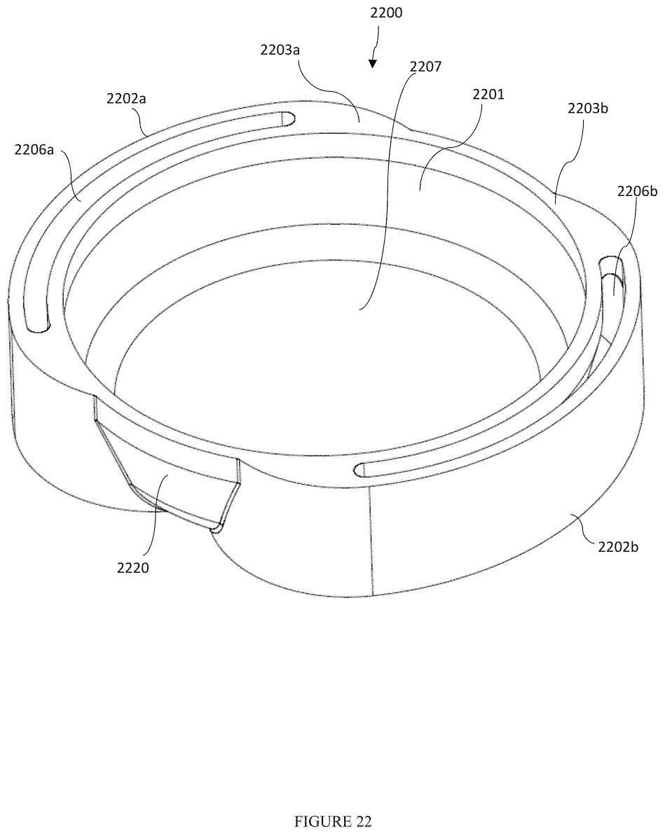

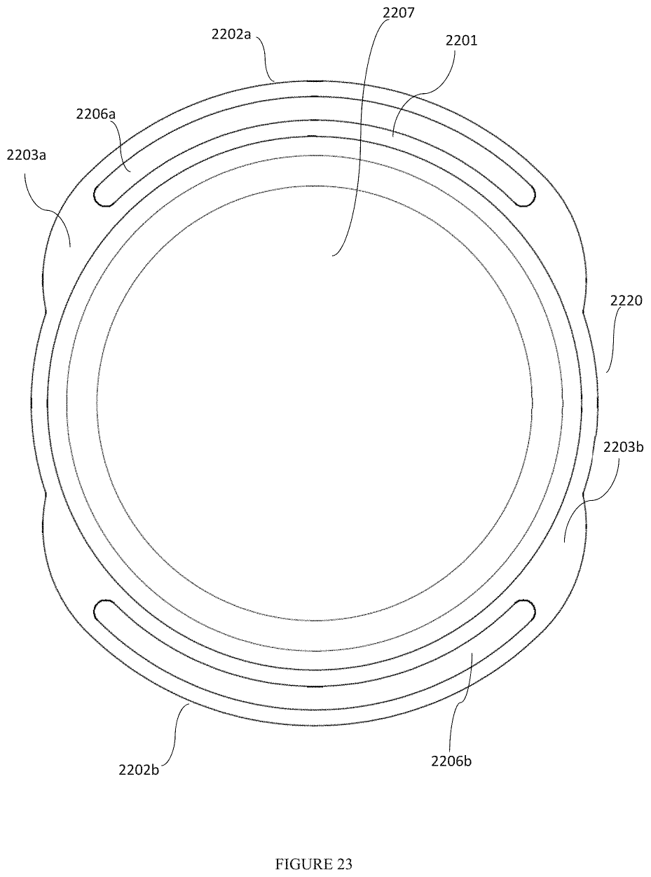

In some embodiments, the second wall need not extend around the entire perimeter of the high heat flux pan. For example, with reference to FIGS. 22-23, a cooking pan 2200 having one or more gaps 2220 defined in the second wall 2202 is depicted in accordance with an embodiment of the disclosure. In this embodiment, pan 2200 can include a base 2207 with an internal heating wall 2201 extending generally perpendicular to the base 2207, and second walls 2202 extending generally parallel to the internal heating wall 2202. A void can be defined between the internal heating wall 2201 and the second walls 2202 to define one or more heat conduction channels 2206. Unlike previous embodiments, the internal heating wall 2201 and the second wall 2202 need not be connected with a plurality of integrally formed ribs or other connecting features. Rather, the second wall 2201 can define one or more connection points 2203 to establish contact for thermal conduction between the second wall 2202 and the internal heating wall 2201. In some embodiments, such an arrangement can define gaps 2220 for attaching accessories, such as handles, pour spouts or the like.

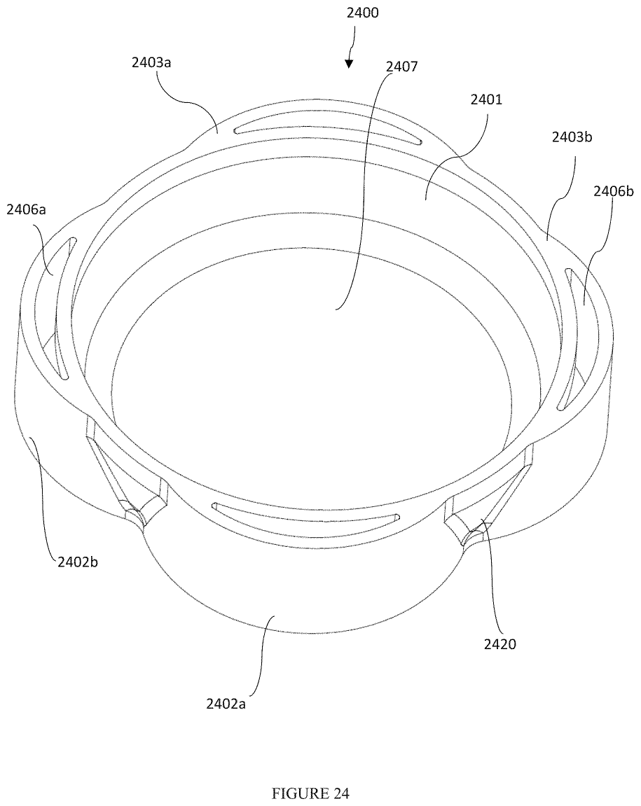

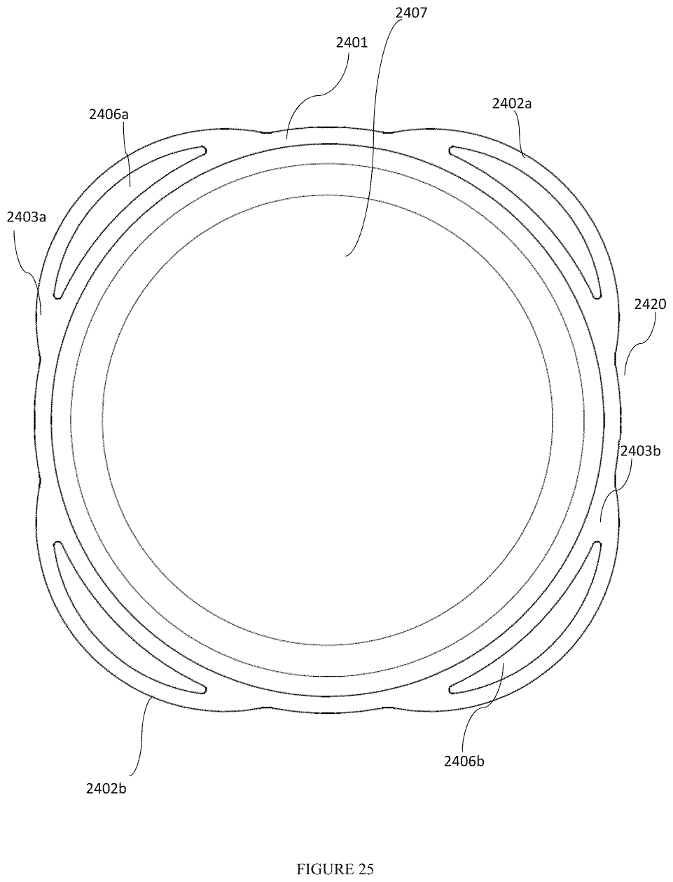

Referring to FIGS. 24-25, another example embodiment of a high heat flux pan 2400 defining one or more gaps 2420 is depicted in accordance with the disclosure. In this embodiment, pan 2400 can include a base 2407 with an internal heating wall 2401 extending generally perpendicular to the base 2407 and second walls 2402 extending generally parallel to the internal heating wall 2402. A void can be defined between the internal heating wall 2401 and the second walls 2402 to define one or more heat conduction channels 2406. Like the previous embodiment, the internal heating wall 2401 and the second wall 2402 need not be connected with a plurality of integrally formed ribs or other connecting features. Rather, outer walls 2406 can define a profile such that outer wall 2406 intersects with the internal heating wall 2401 at multiple points 2403 to establish contact for thermal conduction between the second wall 2402 and the internal heating wall 2401. In some embodiments, such an arrangement can define gaps 2420 for attaching accessories, such as handles, pour spouts or the like.

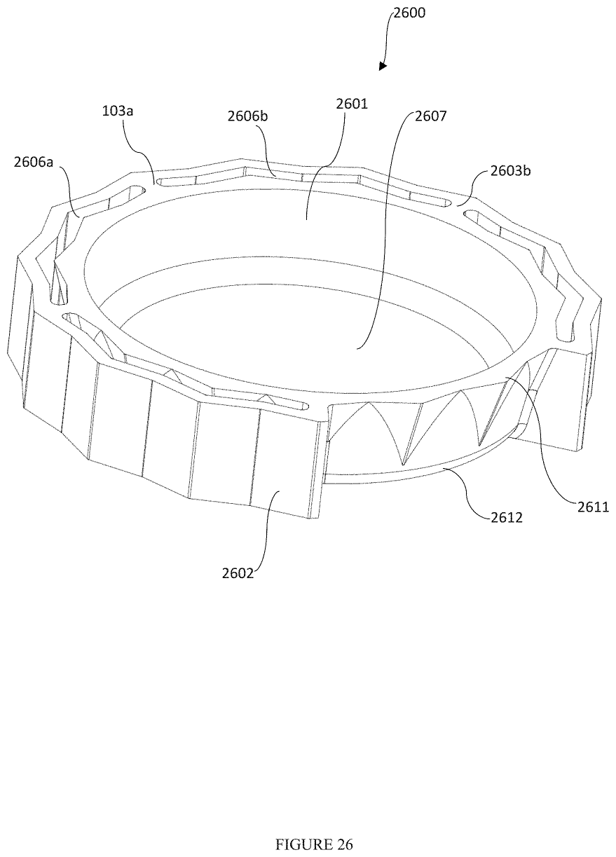

In some embodiments, the heating surface of the internal wall can define a polygonal profile for improved heat conduction, regardless of the shape of the base of the pan. For example, with reference to FIG. 26, high heat flux pan 2600 having an internal wall 2601 with a polygonal profile is depicted in accordance with an embodiment of the disclosure. In this embodiment, the pan 2600 can include a base 2607 with an internal heating wall 2601 extending generally perpendicular to the base 2607, and a second wall 2602 extending generally parallel to the internal heating wall 2602. A void can be defined between the internal heating wall 2601 and the second wall 2602 to define one or more heat conduction channels 2606. In embodiments, the internal heating wall 2601 and the second wall 2602 can be connected with a plurality of integrally formed ribs 2603.

For illustrative purposes, a section of second wall 2602 is cutaway. As depicted, the inner heating wall 2601 can have a non-uniform profile from top to bottom, such that a bottom edge 2612 of internal heating wall 2601 can have an approximately circular profile, with the profile gradually changing along the vertical axis to a polygonal profile along a top edge 2611 of internal heating wall 2601. In embodiments, the second wall 2602 can have a uniform profile from top to bottom. Alternatively, the second wall 2602 can have a profile similar to internal heating wall 2601, or any other unique, non-uniform profile.

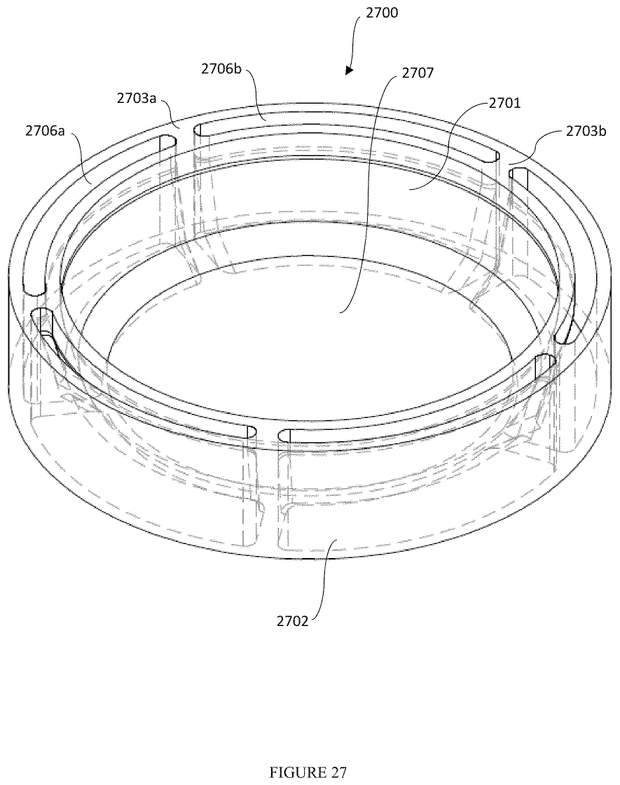

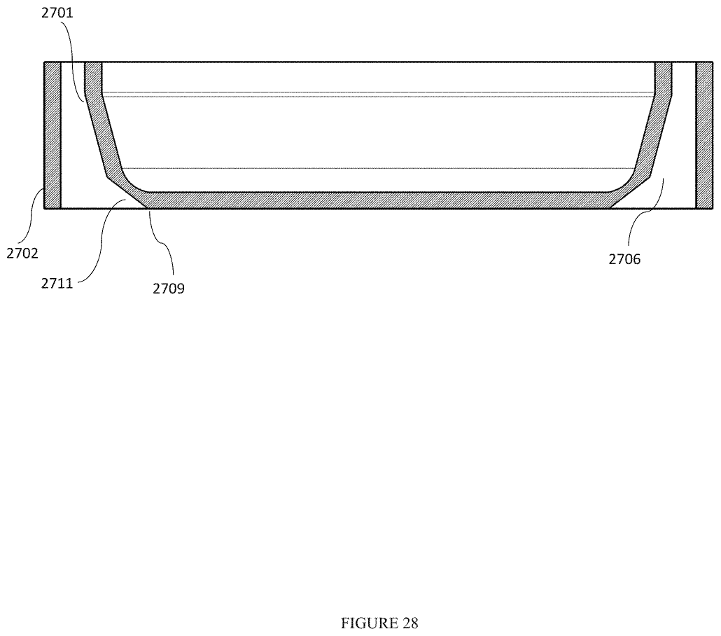

In some embodiments, rather than a curved radius along a peripheral edge of the base, the high heat flux pan can include a chamfer or angled transition between the base and the internal heating wall. For example, with reference to FIGS. 27-28, a high heat flux pan 27 with a chamfered (angled) surface 2711 is depicted in accordance with an embodiment of the disclosure. In this embodiment and 2700 can include a base 2707 with an internal heating wall 2701 extending generally perpendicular to the base 2707, and a second wall 2702 extending generally parallel to the internal heating wall 2702. A void can be defined between the internal heating wall 2701 and the second wall 2702 to define one or more heat conduction channels 2706. In embodiments, the internal heating wall 2701 and the second wall 2702 can be connected with a plurality of integrally formed ribs 2703. In embodiments, a junction of a peripheral edge 2709 of the pan and internal heating wall 2701 can be in the form of a chamfered (angled) surface 2711. In embodiments, the chamfered surface 2711 can be configured to provide a gradual change in direction from horizontal to vertical for hot gases proximal to lower edge of pan 2709 and internal heating wall 2701, similar to the radius found on other embodiments.

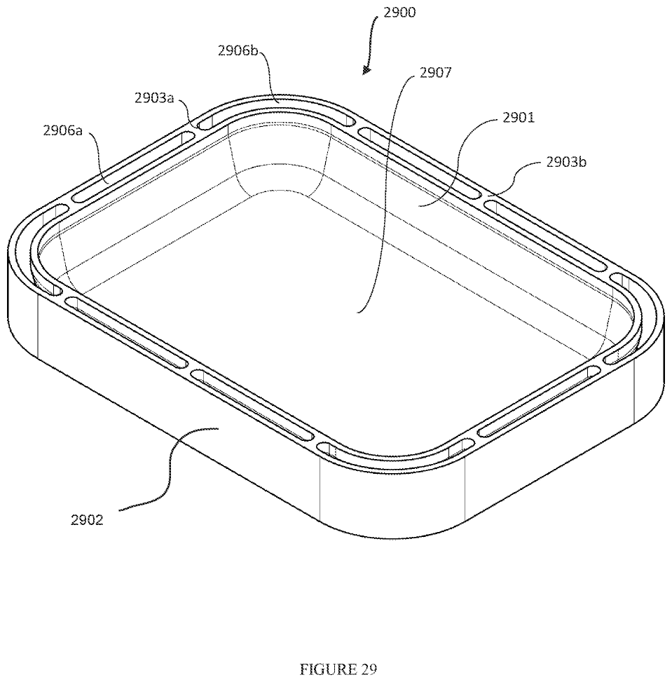

In some embodiments, rather than having a circular, oval, elliptical, or polygonal shape, the high heat flux pan can generally be a square or rectangular shape. For example, with reference to FIG. 29, a rectangular shaped high heat flux pan 2900 is depicted in accordance with an embodiment of the disclosure. In this embodiment, the pan 2900 can include a base 2907 with an internal heating wall 2901 extending generally perpendicular to the base 2907, and a second wall 2902 extending generally parallel to the internal heating wall 2902. A void can be defined between the internal heating wall 2901 and the second wall 2902 to define one or more heat conduction channels 2906. In embodiments, the internal heating wall 2901 and the second wall 2902 can be connected with a plurality of integrally formed ribs 2903.

Initial test results show that embodiments of the high heat flux pan excel at absorbing the energy of a flame or gaseous energy for transfer to food placed within the pan, thereby enabling a greater amount of thermal energy to enter the food over a given period of time, and at a lower temperature, which is particularly important when searing or caramelizing food items such as onions, Asian cuisine, vegetables, beef or fish, etc. For example, with reference to FIG. 30A, a graphical representation of a measured heat flux for a high heat flux pan (HHFP) and a conventional pan (Control) over a range of input powers is depicted in accordance with an embodiment of the disclosure. As depicted, the y-axis represents the heat flux in kilowatts, while the x-axis represents input power in kilowatts. As depicted, the high heat flux pan provides a higher heat flux compared to the conventional pan, particularly at higher input power levels.

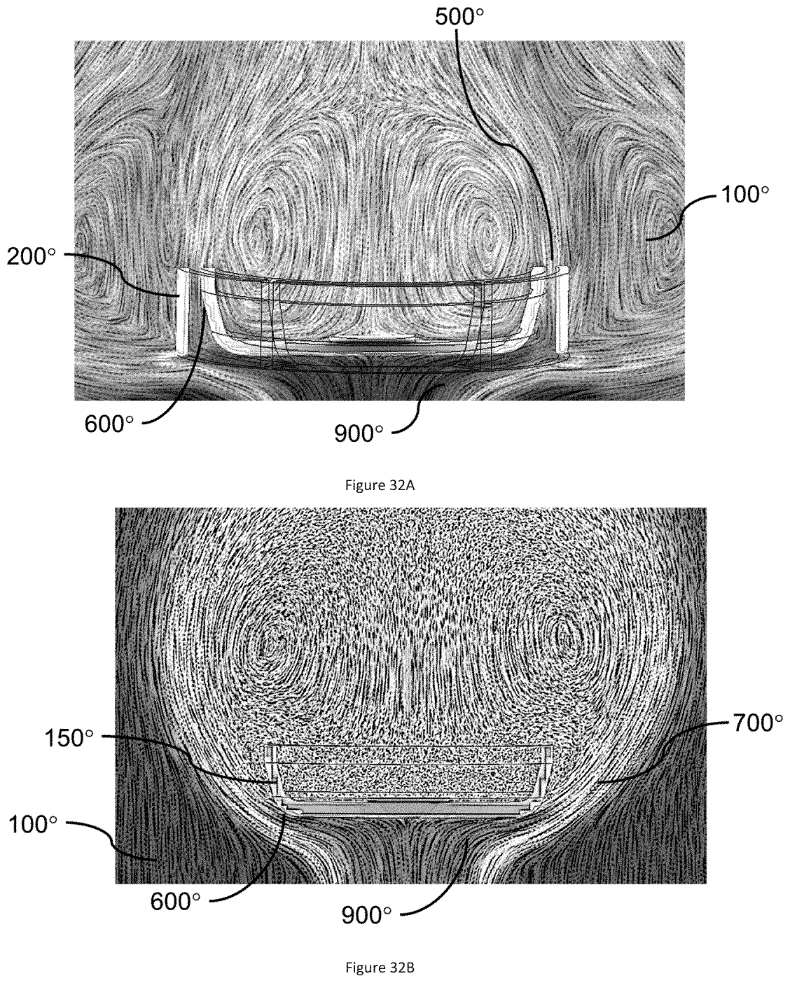

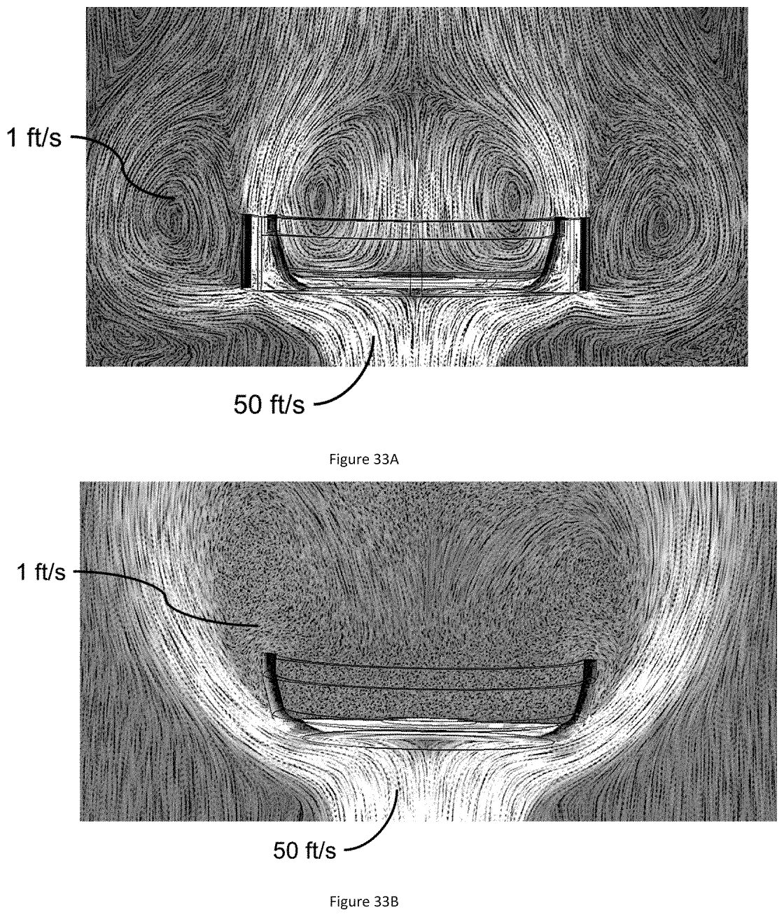

With additional reference to FIGS. 32A-B and FIGS. 33A-B, graphical depictions of representative temperatures and velocities relative to a flow of hot gases passing over the high heat flux pan and conventional pan are depicted. Specifically, FIG. 32A depicts the temperature and direction of a flow of a 900° FHS directed at the bottom of the high heat flux pan, in accordance with an embodiment of the disclosure. While FIG. 32B depicts the temperature and direction of a flow of a 900° FHS directed at the bottom of a conventional pan. As can be seen from FIG. 32A, got gas enters the HCC at 900°, transfers energy to the high heat flux pan, and exits the HCC at 500°. This energy transfer results in both conducting surfaces of the HCC being heated to 600°, while the interior of the pan is at 200°, and the ambient atmosphere is warmed to 100°. As can be seen from FIG. 32B, hot gas contacts the bottom of the conventional pan at 900°, then detaches from the pan primary side wall at 700°, mixing with the 100° atmosphere. This results in an energy transfer, heating the bottom of the pan and the lower edge of the pan primary sidewall only to 600°, while the interior of the pan is at 150°. Similarly, FIG. 33A depicts a velocity of a flow of a 50 ft/s FHS directed at the bottom of the high heat flux pan, in accordance with an embodiment of the disclosure. While FIG. 33B depicts the velocity of a flow of a 50 ft/s FHS directed at the bottom of a conventional pan. For comparison, resultant slow-moving gas at 1 ft/s is also noted. As can be seen in the graphical depictions, with the high heat flux pan, the flow of hot gas is directed through the heat conduction channels, such that more heat from the flow of hot gas is absorbed by the high heat flux pan, in comparison to the conventional pan.

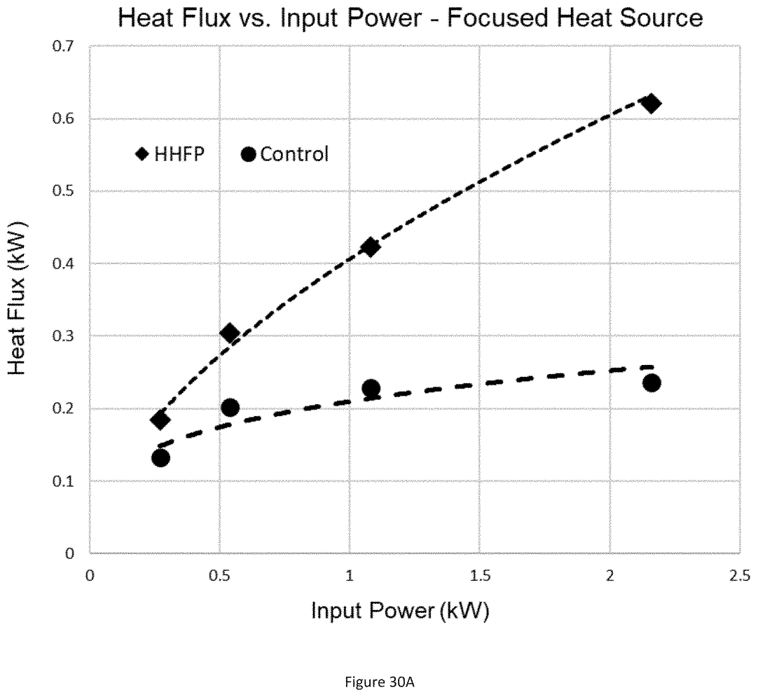

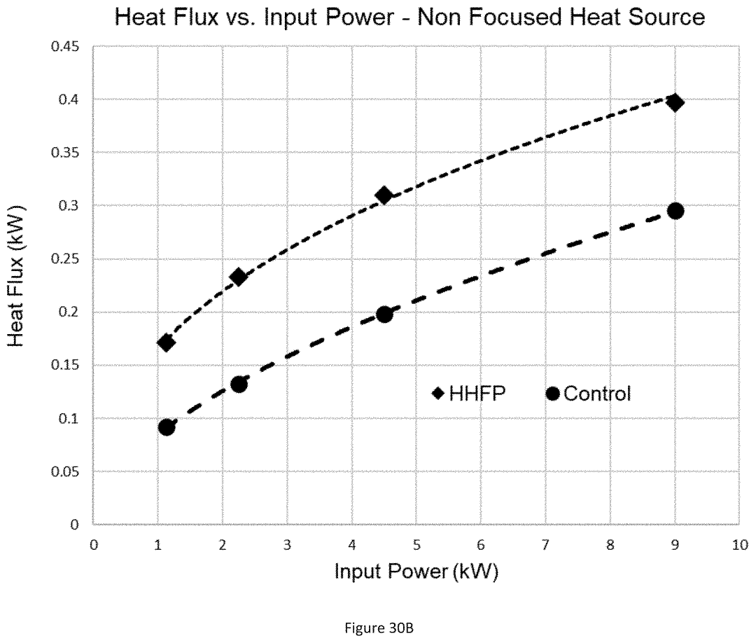

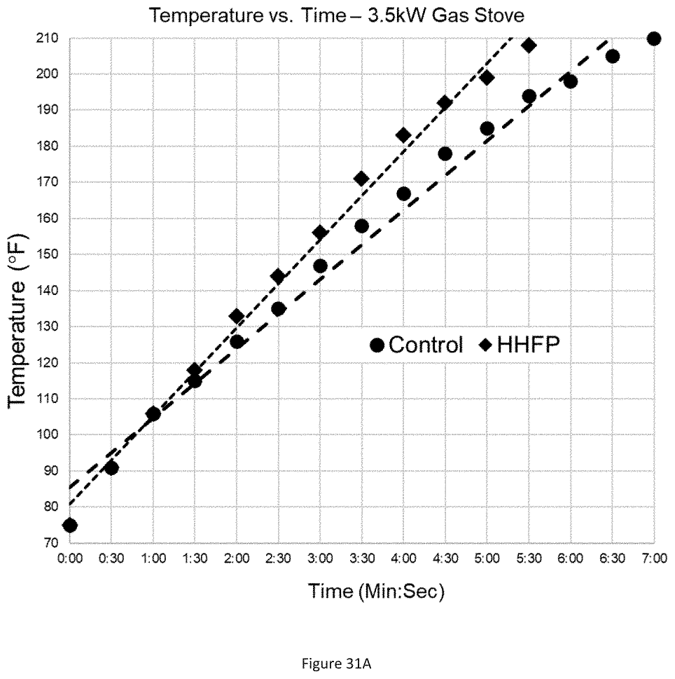

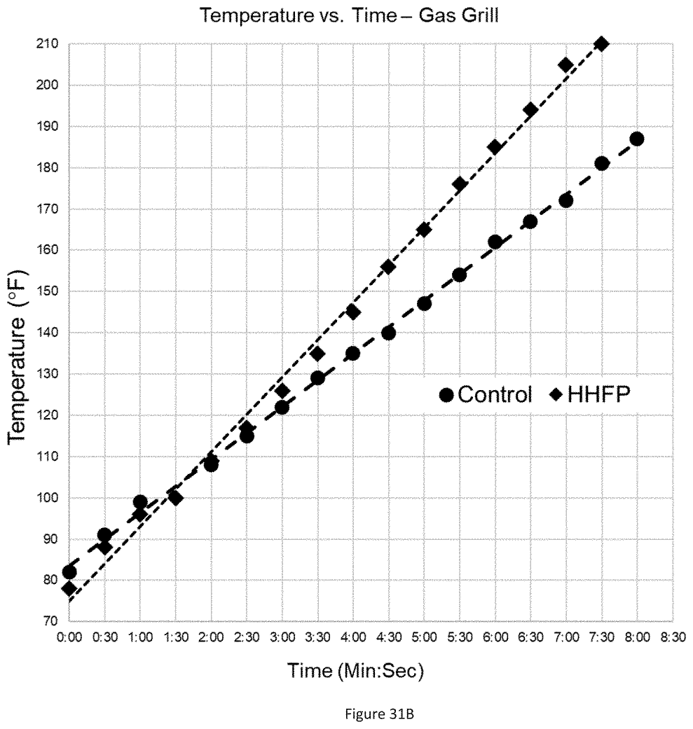

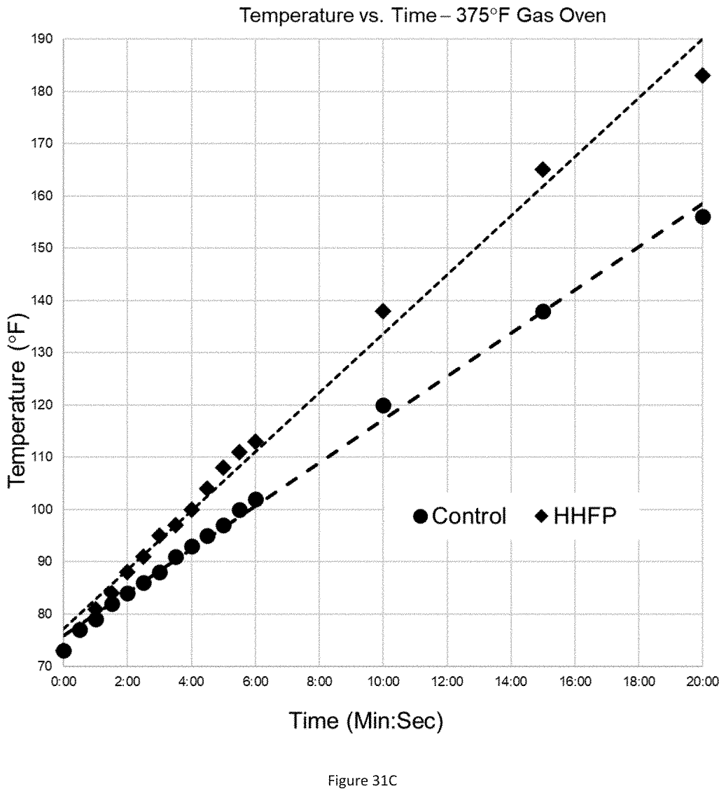

In addition to having a higher heat flux capacity, the high heat flux pan also heats faster than a conventional pan. For example, with reference to FIG. 31A, a graphical representation of a measured temperature for a high heat flux pan (HHFP) and a conventional pan (Control) over a period of time, is depicted in accordance with an embodiment of the disclosure. The measured temperatures are of water so as to measure the flux. As depicted, the y-axis represents the temperature in Fahrenheit, while the x-axis represents time in minutes and seconds. As depicted, the high heat flux pan generally heats much faster in comparison to the conventional pan.

In addition to functioning well over a gas stove or focused source of heat, the high heat flux pan also excels over an unfocused energy source, such as a grill, fire pit or oven. For example, with reference to FIG. 30B, a graphical representation of a measured heat flux for a high heat flux pan (HHFP) and a conventional pan (Control) over a range of input powers is depicted in accordance with an embodiment of the disclosure. As depicted, the y-axis represents the heat flux in kilowatts, while the x-axis represents input power in kilowatts. As depicted, even in an unfocused energy source, the high heat flux pan provides a higher heat flux compared to the conventional pan.

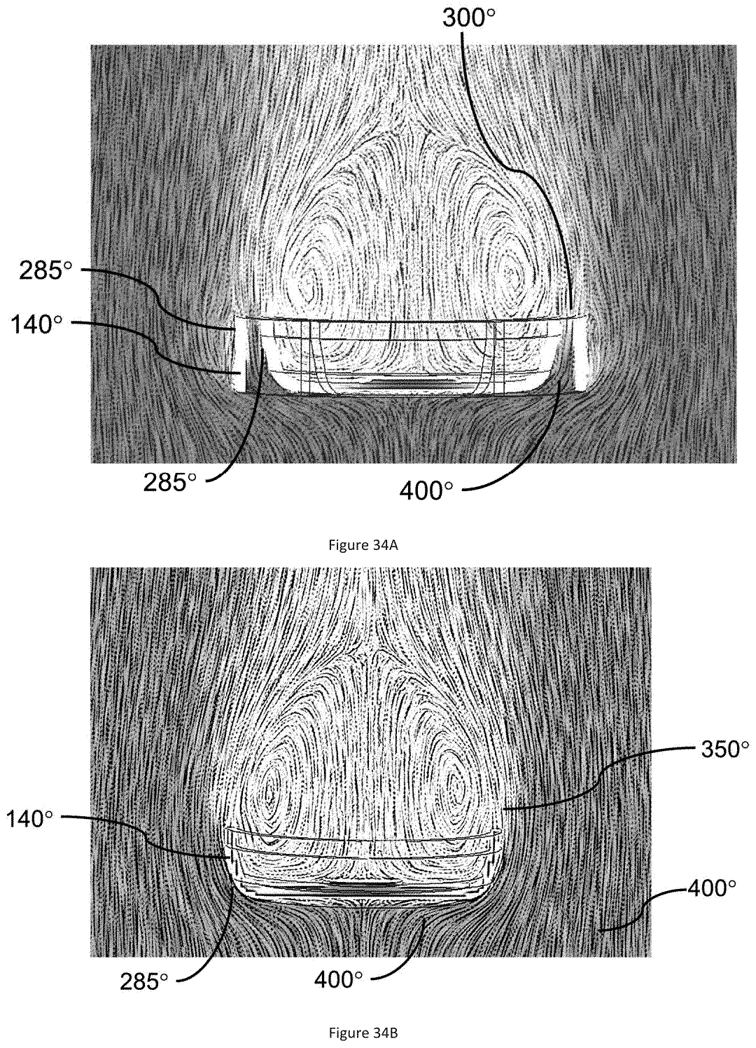

With additional reference to FIGS. 34A-B, graphical depictions of representative temperatures of a flow of gases originating from a NFHS at 400° passing over the high heat flux pan and conventional pan are depicted. Specifically, FIG. 34A depicts the temperature of a high heat flux pan and gases flowing around it as well as the direction of flow of said gases, in accordance with an embodiment of the disclosure. While FIG. 34B depicts the temperature of a conventional pan and gases flowing around it as well as the direction of flow of said gases. Heat absorbing surfaces are heated to approximately 285° while the interior of the pan remains cooler at 140°. Gas enters the HCC at approximately 400° and exits at approximately 300° after transferring energy to the high heat flux pan. With the conventional pan, gas is cooled to 350° after contacting heat absorbing surfaces of the pan. As can be seen in the graphical depictions, with the high heat flux pan, heat absorbing surfaces are increased by a factor of three compared to the conventional pan. That is, even in cases where there is not sufficient hot gas to create a concentrated flow of very hot gas through the heat conduction channel, there is still a greatly increased surface area to conduct heat from a lower temperature gas into the high heat flux pan, thereby enabling superior heat transfer/flux for cooking of hamburgers over a grill, a casserole over an open fire pit, or stir fried vegetables on a charcoal grill. In an oven setting, pies come out with a crispy crust and soggy edges on deep-dish pizzas can be avoided.

In addition to having a higher heat flux capacity, the high heat flux pan also tends to heat faster than a conventional pan. For example, with reference to FIG. 31B-C, a graphical representation of a measured temperature for a high heat flux pan (HHFP) and a conventional pan (Control) over a period of time is depicted in accordance with an embodiment of the disclosure. In particular, FIG. 31B depicts a rise in temperature when subjected to heat from a gas grill, while FIG. 31C depicts a rise in temperature when subjected to heat from an oven. As depicted, the y-axes of FIGS. 31B-C represent the temperature in Fahrenheit, while the x-axes represent time in minutes and seconds. As depicted, the high heat flux pan generally heats much faster in comparison to a conventional pan.

In embodiments, the high heat flux pan can be constructed of a highly conductive material including, but not limited to aluminum. The high heat flux pan can also be constructed of other conductive materials, such as copper and aluminum, among others, or lesser conductive materials, such as cast iron. For example, constructing the high heat flux pan out of an aluminum alloy provides a pan that is substantially equal in conductivity, superior a heat capacity and lighter weight than a copper or cast-iron equivalent. In particular, initial studies have shown that embodiments of the present disclosure, under preferred conditions, conduct up to 93% more heat energy from a gas range into food when made out of an alloyed aluminum material. By contrast, up to a 68% improvement is noted when made from gray cast iron. In general, the improvements are highly correlated with the power of the burner beneath (e.g., the more powerful the burner, the greater the improvement). Over a non-focused heat source such as a fire or grill, an improvement of up to 56% is seen when made of aluminum, while up to a 28% is observed when constructed of cast iron.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A cooking vessel configured to enable improved airflow around heating surfaces resulting in enhanced heating and cooking efficiency, the cooking vessel comprising:
a base defining a bottom surface representing a first heat conductive surface;
an inner wall extending upwardly away from the base, the inner wall defining an outer surface representing a second heat conductive surface; and
an outer wall at least partially surrounding the inner wall, the outer wall defining an inner surface representing a third heat conductive surface,
wherein the bottom surface of the base defines at least one of a filleted or chamfered peripheral edge configured to promote adhesion of a flow of gas over the first and second heat conductive surfaces,
wherein the second and third heat conductive surfaces cooperate to define a channel through which a flow of gas is directed, the channel being tapered along a length of the second and third heat conductive surfaces to promote a continuous flow of gas through the channel as the gas cools and decreases in volume, and
wherein the second and third heat conductive surfaces further cooperate to define an exit nozzle having an area relative to a cross sectional area of the channel, the exit nozzle configured to enable the continuous flow of gas to exit the channel.

2. The cooking vessel of claim 1, wherein the peripheral edge of the bottom surface of the base has a radius of between about 0.125 inches and about 1.50 inches.

3. The cooking vessel of claim 1, wherein the channel has a taper angle measuring between about 5° and about 45°.

4. The cooking vessel of claim 1, wherein the exit nozzle defines a peripheral gap measuring between about 0.0625 inches to about 1.00 inches.

5. The cooking vessel of claim 1, wherein the exit nozzle has a taper angle measuring less than 15°.

6. The cooking vessel of claim 1, wherein the outer wall further defines an outer surface representing a fourth heat conductive surface.

7. The cooking vessel of claim 1, wherein the cooking vessel is a unitary member, wherein the outer wall is operably coupled to at least one of the inner wall or base without the use of fasteners or adhesives.

8. The cooking vessel of claim 1, wherein the outer wall is operably coupled to at least one of the inner wall or base by one or more ribs.

9. The cooking vessel of claim 1, wherein the outer wall further defines an outer surface configured in at least one of a circular, oval, elliptical, square, rectangular, polygonal, or irregular shape.

10. The cooking vessel of claim 1, further comprising one or more handles.

11. The cooking vessel of claim 1, wherein the exit nozzle has an area not less than 25% of an average cross sectional area of the channel.

12. The cooking vessel of claim 1, wherein an upper vertical elevation gap is defined between the outer wall and the inner wall.

13. The cooking vessel of claim 1, wherein a lower vertical elevation gap is defined between the outer wall and the inner wall.

14. The cooking vessel of claim 1, wherein at least one of the inner wall or outer wall define one or more serrations configured to promote turbulence within the flow of gas.

15. The cooking vessel of claim 1, wherein both the inner wall and outer wall extend upwardly and at an acute angle relative to the base.

16. The cooking vessel of claim 1, wherein the outer wall defines one or more connection points to establish contact for thermal conduction between the outer wall and the inner wall.

17. The cooking vessel of claim 1, wherein at least one of the inner wall or outer wall defines a non-uniform profile.

18. The cooking vessel of claim 1, wherein the channel is defined with an approximately circular profile proximal to a bottom edge of the channel and a polygonal profile proximal to a top edge of the channel.

19. A cooking vessel comprising:
a base;
an inner wall extending upwardly away from the base; and
an outer wall at least partially surrounding the inner wall, wherein the base defines at least one of a filleted or chamfered peripheral edge, and wherein the inner and outer walls cooperate to define a tapered channel and an exit nozzle having an area relative to a cross sectional area of the tapered channel.

20. A cooking vessel configured to enable improved airflow around heating surfaces resulting in enhanced heating and cooking efficiency, the cooking vessel comprising:
a base defining a bottom surface representing a first heat conductive surface;
an inner wall extending upwardly away from the base, the inner wall defining an outer surface representing a second heat conductive surface; and
an outer wall at least partially surrounding the inner wall operably coupled to at least one of the inner wall or base by one or more ribs, the outer wall defining an inner surface representing a third heat conductive surface,
wherein the bottom surface of the base defines at least one of a filleted or chamfered peripheral edge configured to promote adhesion of a flow of gas over the first and second heat conductive surfaces, wherein the peripheral edge of the bottom surface of the base has a radius of between about 0.125 inches and about 1.50 inches,
wherein the second and third heat conductive surfaces cooperate to define a channel through which a flow of gas is directed, the channel being tapered along a length of the second and third heat conductive surfaces to promote a continuous flow of gas through the channel as the gas cools and decreases in volume, wherein the channel has a taper angle measuring between about 5° and about 45°,
wherein the second and third heat conductive surfaces further cooperate to define an exit nozzle having an area relative to a cross sectional area of the channel, the exit nozzle configured to enable the continuous flow of gas to exit the channel, wherein the exit nozzle has a taper angle measuring less than 15°, wherein the exit nozzle defines a peripheral gap measuring between about 0.0625 inches to about 1.00 inches.
